(19) United States
(12) Patent Application Publication
(10) Pub. No.: US 2024/0420259 A1
(43) Pub. Date: Dec. 19, 2024

(54) INFORMATION ANALYSIS DEVICE, AND STORAGE MEDIUM

(71) Applicant: CCReB Advisors Inc., Tokyo (JP)

(72) Inventor: Yukihiro MIYADERA, Tokyo (JP)

(73) Assignee: CCReB Advisors Inc., Tokyo (JP)

(21) Appl. No.: 18/724,036

(22) PCT Filed: Feb. 28, 2023
(86) PCT No.: PCT/JP2023/007219

§ 371 Date: Jun. 25, 2024

(30) Foreign Application Priority Data
Feb. 28, 2022 (JP) 2022-030518
Feb. 28, 2022 (JP) 2022-030519
Feb. 28, 2022 (JP) 2022-030520

(51) Int. Cl. G06Q 50/163

(52) U.S. Cl. CPC G06Q 50/163

(57) ABSTRACT

By specifying an analysis range and performing keyword analysis on management information, a true trend of company real estate utilization, as identified from the management information, are visualized using keywords. A device includes: a storage unit 14 that stores a real estate keyword relevant to real estate utilization of a company; an information acquisition unit 121 that acquires management information of a plurality of companies; an analysis range specification unit 122 that specifies an analysis range for the management information; an analysis unit 124 that analyzes and extracts within the analysis range the real estate keyword from among keywords contained in management information of each of the companies acquired by the information acquisition unit; and an output unit 130 that outputs display data for displaying a keyword display field containing the real estate keyword of the company extracted by the analysis unit as individual information for the company.

### TECHNICAL FIELD

The present invention relates to an information analysis device that analyzes real estate information from management information of a company.

### BACKGROUND ART

Patent Literature 1 discloses a technique for listing and displaying companies likely to have real estate transaction demands by analyzing company management information such as mid-term management plans and securities reports.

### CITATION LIST

### Patent Literature

[Patent Literature 1] Japanese Laid-Open Patent Publication No. 2021-039724

### SUMMARY OF THE INVENTION

### Problem to be Solved by the Invention

However, while the technique disclosed in Patent Literature 1 is revolutionary in that it can list potential client company candidates in descending order of their likelihood of real estate transaction demand, keywords are not displayed. Moreover, determining the real estate utilization interests of these client companies or searching for trending topics with keywords are not easy and require time and effort. Taking these factors into consideration, an object of the present invention is to provide an information analysis device capable of visualizing keywords and specific essential information obtained through the analysis of company management information and property information, thereby allowing for a quick understanding of the real estate utilization trends of those companies.

### Solution to Problem

In order to solve the above problems, an information analysis device of the present invention includes: a storage unit that stores a real estate keyword relevant to real estate utilization of a company; an information acquisition unit that acquires management information of a plurality of companies; an analysis range specification unit that specifies an analysis range for the management information; an analysis unit that analyzes and extracts within the analysis range the real estate keyword from among keywords contained in management information of each of the companies acquired by the information acquisition unit; and an output unit that outputs display data for displaying a keyword display field containing the real estate keyword of the company extracted by the analysis unit as individual information for the company.

According to the information processing device of such an aspect, management information of multiple companies is acquired and real estate keywords relevant to company real estate utilization are analyzed and extracted within an analysis range of specified management information, and therefore, it is possible to highlight keywords more distinctively than those frequently used by the companies, for example. As a result, the true trends of the company real estate utilization identified from the management information can be visualized using keywords, and this enables a quick understanding of the real estate utilization trends of companies with a high potential for real estate transaction demand.

In a preferred aspect of the present invention, the storage unit may store a hot keyword relevant to a trend in an environment surrounding the company, the analysis unit may separately analyze and extract the real estate keyword and the hot keyword from keywords contained in the management information acquired by the information acquisition unit, and the keyword display field may include a first keyword display field that contains the real estate keyword extracted by the analysis unit and a second keyword display field that contains the hot keyword. According to such an aspect, real estate keywords indicating real estate utilization trends of a company and hot keywords indicating industry trends of the company are displayed. It is therefore possible to grasp at a glance the real estate utilization trends of the company and the environmental trends surrounding its industry, making it also easier to grasp the rationale behind the company's real estate utilization trends. As a result, a deeper understanding of the real estate utilization trends of the company becomes possible, making it easier to devise sales strategies that deeply resonate with the company.

In a preferred aspect of the present invention, the hot keyword may include a hot keyword associated with each industry, the analysis range specification unit may specify, as an analysis range, management information of the plurality of companies included in an industry of the company of the management information acquired by the information acquisition unit, and the analysis unit may analyze and extract a hot keyword associated with the industry from the management information within the analysis range. According to such an aspect, the analysis range for hot keywords encompasses not only the management information of an individual company but the management information of multiple companies within the industry including the company, and it is therefore possible to efficiently acquire hot keywords for the entire industry, encompassing not only the company itself but also other companies within the industry.

In a preferred aspect of the present invention, the analysis range specification unit may also include past management information in the analysis range, the analysis unit may extract as a latest keyword, from among keywords contained in the management information of the company acquired by the information acquisition unit, a keyword that is not contained in past management information of the company, and the output unit may output display data for displaying the latest keyword in priority to another keyword. According to such an aspect, among the keywords contained in management information of a company acquired by the information acquisition unit, keywords that are not contained in the past management information of the company are extracted as the latest keywords. The reason for this is that management information of the same company is often issued regularly in a similar format, and thus utilizing past management information from the same company enables efficient extraction of its latest keywords. Also, the latest keywords are displayed in priority to other keyword, and it is therefore possible to highlight distinctive terms that have recently emerged over commonly used terms within the company, for example. As a result, a quick understanding of real estate utilization trends of the company becomes possible, making it easier to devise sales strategies.

In a preferred aspect of the present invention, the analysis unit may separately extract the real estate keyword contained in the management information acquired by the information acquisition unit and the real estate keyword contained in the past management information, and the output unit may output display data for displaying, in the first keyword display field, the real estate keyword contained in the past management information in addition to the real estate keyword contained in the management information acquired by the information acquisition unit. According to such an aspect, past real estate keywords and the latest real estate keywords can be compared, and it is therefore possible to grasp at a glance trend changes in real estate utilization trends of the company.

In a preferred aspect of the present invention, the information acquisition unit may acquire real estate property information of the plurality of companies, there may be provided an essential information specification unit that specifies essential information for real estate properties from the real estate property information, the analysis unit may analyze and extract the essential information from the real estate property information of each of the companies acquired by the information acquisition unit, and the output unit may output display data for displaying an essential information display field containing the essential information of the company extracted by the analysis unit as individual information of the company. According to such an aspect, essential information that is specified from real estate property information of a company is analyzed and displayed, and it is therefore possible to narrow down and display specific essential information from numerous sets of information of each property. This allows specific essential information to be visualized as individual information of the company, making it easier to quickly identify truly necessary real estate properties as compared to the conventional practice of simply incorporating more information.

In a preferred aspect of the present invention, the information acquisition unit may acquire real estate property information containing at least a location, a use, a use zone, and a scale of the real estate property from management information of a company, and the analysis unit may analyze and extract the essential information from the real estate property information of the management information. According to such an aspect, since essential information, including at least the location, the use, the use zone, and the scale of the real estate property are analyzed and extracted, and it is therefore possible to visualize essential minimum information for a user searching for company real estate.

In a preferred aspect of the present invention, the information acquisition unit may acquire demand information containing essential information for the real estate properties, the analysis unit may calculate a matching score by comparing and analyzing the essential information for the real estate properties in the demand information and the essential information for the real estates extracted by the analysis unit, and the display data may contain data for displaying the essential information in descending order of the matching score. According to such an aspect, essential information for real estate properties is the essential minimum information for searching company real estate, enabling matching with such minimal data, and therefore matching of real estate that meets user's needs can be made more easily as compared to cases where matching is made with more information. As a result, it becomes easier to find real estate that meets user's needs.

In a preferred aspect of the present invention, the information acquisition unit may acquire map information, and the display data may contain an essential information display field that displays essential information for real estate properties having the matching score equal to or greater than a predetermined value, and a map information display field that displays the matching score overlaid on a map from the map information and positions of the real estate properties on the map. According to such an aspect, the map information display field is displayed in which specific essential information display field for an approximate target region and a matching score are overlaid on the map, and it is therefore easy to quickly find properties that meet needs in the approximate targeted region.

In a preferred aspect of the present invention, the display data may contain a property count display field that displays the number of real estate properties for each region on the map, and an essential-matched property count display field that displays the number of properties for each item of the essential information. According to such an aspect, the property count display field overlaying the number of real estate properties for each region on the map is displayed, and it is therefore possible to grasp at a glance the number of real estate properties in each region. Additionally, the essential-information-matched property count display field allows the number of properties to be understood for each item of the essential information, and it is therefore possible to easily approximate company real estate properties that meet needs.

In a preferred aspect of the present invention, the storage unit may store a specific keyword relevant to a real estate transaction of a company, there may be provided a keyword determination unit that determines whether or not the specific keyword is contained in management information acquired by the information acquisition unit, and a company selection unit that selects as a potential client company candidate a company determined by the keyword determination unit as containing the specific keyword in the management information, and the output unit may output display data for displaying a company candidate display field containing the potential client company candidate selected by the company selection unit, and display data for displaying in an emphasized manner a company specified in the company candidate display field and for listing and displaying the individual information of the specified company in the company candidate display field. According to such an aspect, from company management information, companies with potential real estate transaction demands are displayed as potential client company candidates, and even keywords relevant to real estate transactions and real estate utilization are visualized as individual information of the companies. Therefore, it is possible to grasp at a glance real estate transaction trends and utilization trends of the company, making it easy to develop real estate sales strategies for the company.

In order to solve the above problems, a storage medium of the present invention is a storage medium that is computer-readable and stores therein a program for causing a computer to execute information analysis processing on management information containing a real estate keyword relevant to real estate utilization of a company, wherein the information analysis processing comprises steps of: acquiring management information of a plurality of companies; specifying an analysis range for the management information; analyzing and extracting within the analysis range the real estate keyword relevant to real estate utilization from among keywords contained in the management information of each of the companies acquired by the information acquisition unit; and outputting display data for displaying a keyword display field containing the real estate keyword of the company extracted by the analysis unit as individual information for the company. By reading and executing the program stored in the storage medium of such an aspect with a computer, the information analysis processing of the present invention can be performed, thereby enabling the computer to function as an information analysis device.

In order to solve the above problems, a program of the present invention is an information analysis program that is a program for causing a computer to execute information analysis processing on management information containing a real estate keyword relevant to real estate utilization of a company, wherein the information analysis processing comprises steps of: acquiring management information of a plurality of companies; specifying an analysis range for the management information; analyzing and extracting within the analysis range the real estate keyword relevant to real estate utilization from among keywords contained in the management information of each of the companies acquired by the information acquisition unit; and outputting display data for displaying a keyword display field containing the real estate keyword of the company extracted by the analysis unit as individual information for the company. By reading and executing the program of such an aspect with a computer, the information analysis processing of the present invention can be performed, thereby enabling the computer to function as an information analysis device.

In a preferred aspect of the program of the present invention, the information analysis processing may comprise steps of: acquiring real estate property information of a plurality of companies; specifying essential information for real estate properties from the real estate property information; analyzing and extracting the essential information from the real estate property information of each of the companies acquired; and outputting display data for displaying an essential information display field for the company containing the essential information extracted, as individual information for the company.

In a preferred aspect of the program of the present invention, the information analysis processing may comprise steps of: acquiring management information of a plurality of companies; determining whether or not the acquired management information contains a specific keyword relevant to a real estate transaction of a company; selecting as a potential client company candidate a company determined as containing the specific keyword in the management information; and outputting display data for displaying a company candidate display field containing the potential client company candidate selected, together with the individual information.

### Effect of the Invention

According to the present invention, by visualizing keywords and specific essential information obtained by analyzing management information of a company and property information, it is possible to grasp at a glance the real estate utilization trends of the company, making it easier to develop real estate sales strategies for the company.

### BRIEF DESCRIPTION OF THE DRAWINGS

FIG. 1 is a diagram showing a configuration of an information analysis system according to a first embodiment.

FIG. 2 is a block diagram showing a specific configuration example of the information analysis system according to the first embodiment.

FIG. 3 is a diagram showing a configuration example of a keyword database according to the first embodiment.

FIG. 4 is a diagram showing a configuration example of a score database according to the first embodiment.

FIG. 5 is a diagram showing a specific example of a display screen according to the first embodiment.

FIG. 6 is a flowchart showing a specific example of information analysis processing according to the first embodiment.

FIG. 7 is a flowchart showing a specific example of keyword analysis processing according to the first embodiment.

FIG. 8 is a diagram showing a specific example of a display screen according to a second embodiment.

FIG. 9 is a diagram showing a configuration example of a data table for storing hot keywords according to the second embodiment.

FIG. 10 is a diagram showing a configuration example of a data table for storing word scores according to the second embodiment.

FIG. 11 is a block diagram showing a specific configuration example of an information analysis device according to a third embodiment.

FIG. 12 is a diagram showing a configuration example of a data table for storing specific keywords according to the third embodiment.

FIG. 13 is a diagram showing a configuration example of a data table for storing potential client scores according to the third embodiment.

FIG. 14 is a flowchart showing a specific example of information analysis processing according to the third embodiment.

FIG. 15 is a flowchart showing a specific example of specific keyword determination processing according to the third embodiment.

FIG. 16 is a diagram showing a specific example of a display screen according to the third embodiment.

FIG. 17 is a block diagram showing a specific configuration example of an information analysis system according to a fourth embodiment.

FIG. 18 is a diagram showing a configuration example of a keyword database according to the fourth embodiment.

FIG. 19 is a diagram showing a configuration example of a score database according to the fourth embodiment.

FIG. 20 is a diagram showing a specific example of a display screen according to the fourth embodiment.

FIG. 21 is a flowchart showing a specific example of information analysis processing according to the fourth embodiment.

FIG. 22 is a flowchart showing a specific example of matching analysis processing according to the fourth embodiment.

FIG. 23 is a diagram showing a specific example of a display screen according to a fifth embodiment.

FIG. 24 is a diagram showing a specific example of essential information according to the fifth embodiment.

FIG. 25 is a flowchart showing a specific example of information analysis processing according to the fifth embodiment.

FIG. 26 is a block diagram showing a specific configuration example of an information analysis device according to a sixth embodiment.

FIG. 27 is a diagram showing a specific example of a display screen according to the sixth embodiment.

FIG. 28 is a block diagram showing a specific configuration example of an information analysis device according to a seventh embodiment.

FIG. 29 is a diagram showing a specific example of a display screen according to the seventh embodiment.

### DETAILED DESCRIPTION OF THE PREFERRED EMBODIMENTS

### First Embodiment

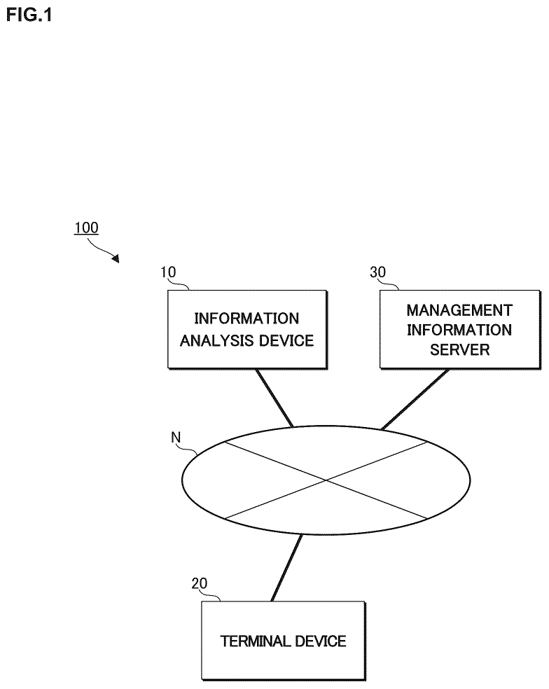

The following describes an information analysis system 100 according to a first embodiment of the present invention, with reference to the drawings. FIG. 1 is a diagram showing a configuration of the information analysis system 100 according to the first embodiment. As shown in FIG. 1, the information analysis system 100 includes an information analysis device 10 and a terminal device 20. The information analysis device 10 of the first embodiment analyzes real estate keywords relevant to real estate utilization obtained from management information such as management plans, and outputs display data that displays the analysis result to the terminal device 20 (hereinafter, this function is also referred to as “first function”). Here, the information analysis device 10 is exemplified as being configured as a server computer with the terminal device 20 serving as a client.

The information analysis device 10 may be configured to perform distributed processing using a plurality of devices, or may be configured using a plurality of virtual machines provided on a single server device. The information analysis device 10 may be configured as a personal computer or a cloud server. The information analysis device 10 and the terminal device 20 are configured to be able to communicate with each other via a network N such as the Internet.

The information analysis device 10 is configured to be able to communicate with an external management information server 30 via the network N. The management information server 30 is a server that provides management information of companies such as management plans and securities reports. The management information server 30 may be a server for providing management information on a company's homepage or the like, or may be a server of a business operator that operates a management information site for providing management information of a number of companies. The network N may consist of an intranet that connects the information analysis device 10 and the terminal device 20, and the Internet that connects the information analysis device 10 and the management information server 30.

The terminal device 20 is an information processing device used by the user. The terminal device 20 is, for example, a mobile terminal such as a smartphone, a tablet, or a PDA (Personal Digital Assistant), a desktop personal computer, or a laptop personal computer. A plurality of terminal devices 20 may be connected to the network N.

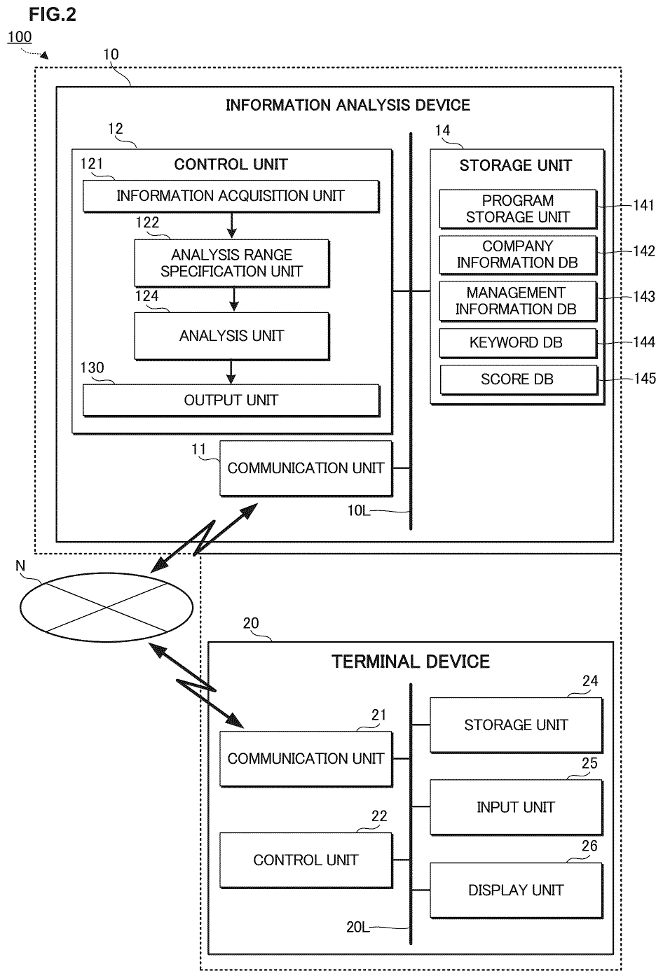

FIG. 2 is a block diagram showing a configuration example of the information analysis system 100 according to the first embodiment. The information analysis device 10 shown in FIG. 2 includes a communication unit 11, a control unit 12, and a storage unit 14. The communication unit 11, the control unit 12, and the storage unit 14 are each connected to a bus line 10L, and can mutually exchange information (data).

The communication unit 11 is connected to the network N via a wired or wireless connection, and transmits and receives information (data) to and from the terminal device 20 and the management information server 30. The communication unit 11 functions as a communication interface for the Internet or an intranet, and is capable of performing communication using, for example, TCP/IP, Wi-Fi (registered trademark), and Bluetooth (registered trademark).

The control unit 12 comprehensively controls the entire information analysis device 10. The control unit 12 is composed of an integrated circuit such as an MPU (Micro Processing Unit). The control unit 12 includes a CPU (Central Processing Unit), a RAM (Random Access Memory), and a ROM (Read Only Memory). The control unit 12 loads necessary programs into the ROM and performs various processes by executing these programs, using the RAM as a work area.

The storage unit 14 is an example of a storage medium (a tangible computer-readable storage medium) that stores an information analysis program described below, other various programs, and data used by these programs executed by the control unit 12. The storage unit 14 is configured with a storage device such as a hard disk or an optical disk. The configuration of the storage unit 14 is not limited to these examples, and the storage unit 14 may be configured with a semiconductor memory such as a RAM or a flash memory. For example, the storage unit 14 can be configured as an SSD (Solid State Drive).

The storage unit 14 includes a program storage unit 141, a company information database 142 (company information DB), a management information database 143 (management information DB), a keyword database 144 (keyword DB), a score database 145 (score DB), and so forth.

The program storage unit 141 stores the information analysis program executed by the control unit 12, and various other programs. The control unit 12 reads out necessary programs from the program storage unit 141 and executes various processes.

The company information database 142 stores company information such as company name, securities identification code (issue code), and listed market (Tokyo Stock Exchange, Nagoya Stock Exchange, Fukuoka Stock Exchange, and so forth) of listed companies. Additionally, the company information database 142 can store information useful for sales of real estate transactions with each company. For example, the company information database 142 may store basic company information such as capitalization, industry sector, business type, employee count, financial closing date, and location.

The management information database 143 stores management information for each company, which will be analyzed by the information analysis device 10. Examples of the management information includes IR (Investor Relations) information for investors, such as management plans (med-term management plans and so forth), securities reports, quarterly reports, and financial results briefing reports. It should be noted that the management information is not limited to IR information, but also includes management-related information that is published on a company's website, for example.

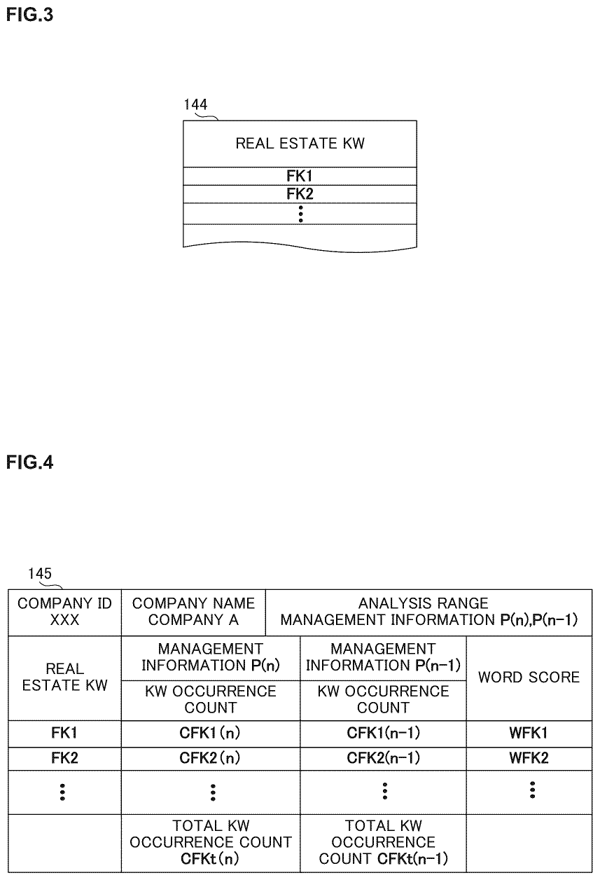

The keyword database 144 stores real estate keywords and the like used in management information analysis. FIG. 3 is a diagram showing a configuration example of the data table of the keyword database 144. As shown in FIG. 3, the keyword database 144 stores real estate keywords such as FK1, FK2, . . . , and so on. Real estate keywords are keywords relevant to real estate utilization of companies. A plurality of real estate keywords are set preliminarily in the keyword database 144. The configuration of the keyword database 144 is not limited to that shown in FIG. 3.

However, text analysis of surveys and emails, for example, cannot determine the management trends of a company such as business activities or utilization of real estate assets. In this context, management information of a company, including mid-term management plans and securities reports, contains keywords relevant to the company's management trends. Therefore, it is considered sufficient to perform text analysis on this management information. However, when real estate keywords were extracted, it was found that frequently used terms within the company or industry (general terms such as “sales”, for example) tend to prevail, while period-characteristic terms (trending terms such as “inbound”, for example) were often less prominent and less noticeable.

This is considered likely because, in management information such as mid-term management plans and securities reports, frequently used terms (such as “sales”, for example) tend to appear more frequently than period-characteristic terms (such as “inbound”, for example). As a result, general terms become more prominent than characteristic terms, making it difficult to accurately grasp the period-specific trends in real estate activities and increasing the risk of misinterpreting the trends. Thus, the terms commonly used vary by company or industry, and it is therefore very difficult to grasp the real estate utilization trends of a company by simply performing keyword analysis on management information.

Through trial and error, it became clear that terms commonly used by companies or industries should also be present in past management information. In particular, mid-term management plans and securities reports are issued on a per fiscal year or per term basis, making them a series of management information that continues over time. Therefore, focusing on this aspect, various analyses were conducted, and it was confirmed that terms commonly used by companies or industries also frequently appear in past management information.

Therefore, in the first embodiment, based on these insights, an analysis range of management information is specified, enabling analysis range specification of not only the latest management information but also past management information. Based on this, conducting comparative analysis with past management information enables an analysis of keywords in the latest management information, and it is thus possible to lower the word score even for terms that appear frequently in the latest management information but also in the past management information, for example. As a result, it becomes possible, for example, to display recently introduced characteristic terms in font sizes larger than those for the terms commonly used by companies or industries every term.

Thus, by specifying the analysis range and performing keyword analysis on management information of a company, it becomes possible to visually highlight characteristic keywords among the keywords relevant to the real estate utilization trends of the company, thereby enabling a quick understanding of the real estate utilization trends in a company that is likely to have real estate transaction demand. Therefore, without relying on the experience and intuition of skilled sales representatives, it is possible to develop strong real estate sales strategies for the company, and by presenting plans tailored to the company's needs, it is possible to increase the success rate of sales.

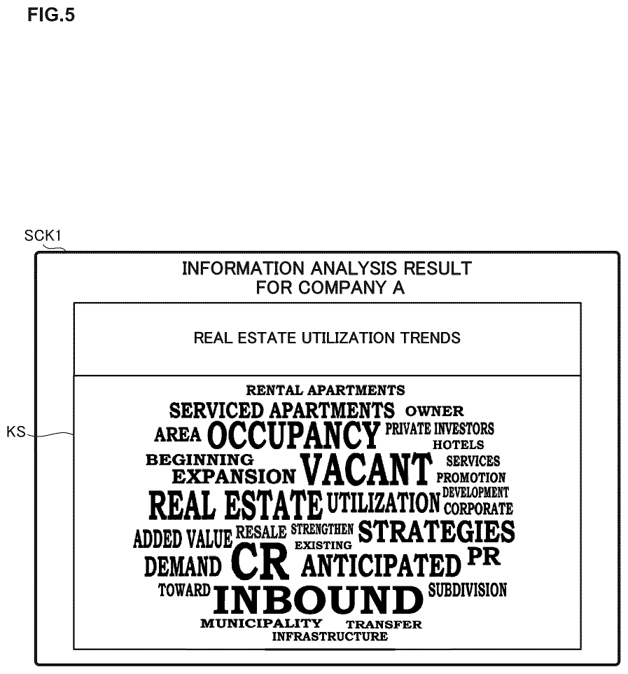

It is preferable that the real estate keywords FK1, FK2, . . . , and so on be keywords that enable a grasp of the real estate utilization trends of a company. For example, as real estate keywords, keywords indicating the real estate utilization trends of a company (such as what kind of real estate there is, how they want to utilize it, whether there are possibilities for buying or renting, including demand and potential demand) are set. Displaying keywords that indicate trends in the real estate utilization of a company allows for anticipation of the needs of the company based on these keywords. Examples of such real estate keywords FK1, FK2, . . . , and so on include “vacant”, “real estate”, “CR”, “demand”, “anticipated”, and “inbound” as shown in FIG. 5.

However, simply extracting these real estate keywords doesn't clearly suggest which keywords are crucial for forecasting trends in real estate utilization. In text analysis of surveys and emails, there are keyword analysis techniques such as text mining, in which the frequency of keyword occurrence is treated as a word score, and the size and color of the text are adjusted according to this word score. With such a technique, the larger the keyword text, the more prominent the keyword becomes, and it is thus conceivable that grasping real estate utilization trends becomes easier.

The word scores of real estate keywords obtained by analyzing management information within the analysis range specified in this manner are associated with each company and stored in a score database 145. FIG. 4 is a diagram showing a configuration example of the data table for storing the keyword database 145 (score DB). In the score database 145 of FIG. 4, company IDs, company names, analysis ranges, real estate keywords (real estate KWs), management information (such as mid-term management plans), and occurrence counts of those keywords (KW occurrence counts) are associated and stored for each company. The configuration of the database for storing word scores of real estate keywords is not limited to that shown in FIG. 4.

FIG. 4 illustrates an example in which management information P(n) and management information P(n−1) are specified as an analysis range. FK1, FK2, . . . , and so on are real estate keywords (real estate KW) of FIG. 3. CFK1(n), CFK2(n), . . . , and so on are the occurrence counts of the real estate keywords FK1, FK2, . . . , and so on in the case of the management information P(n), respectively. CFK1(n−1), CFK2(n−1), . . . , and so on are the occurrence counts of the real estate keywords FK1, FK2, . . . , and so on in the case of the management information P(n−1), respectively. WFK1, WFK2, . . . , and so on are the word scores of the real estate keywords FK1, FK2, . . . , and so on, respectively.

A word score is calculated for each real estate keyword and used, for example, to determine the keyword display (such as font size) as a real estate utilization trend of a company. The keyword occurrence count (KW occurrence count) of FIG. 4 is an occurrence count of each real estate keyword contained in the management information, and the total keyword occurrence count (such as CFKt(n)) is the sum of the occurrence counts of all real estate keywords.

A word score is calculated for each company based on the occurrence count of a real estate keyword in management information within a specified analysis range. Therefore, the word scores in the present embodiment vary depending on the analysis range specified. For example, if the specified analysis range is only the latest management information of the company, the occurrence count of each real estate keyword contained in the latest management information becomes the word score. At this time, for example, the word score may be a value obtained by multiplying the occurrence count by a weighting factor. In such a case, the weighting factor may be adjusted so that the word score is lowered for a real estate keyword that has appeared frequently in past management information. This makes it possible to visualize newer and more characteristic terms in the latest management information in a more prominent manner than terms frequently used in past management information.

For example, if KF1 is a frequently used term “sales” and the occurrence count ratio of KF1 is 10% in the management information P(n−1) and 10% also in management information P(n), then the word score WKF1 derived from the equation (1) will be 0% (=10/10−1×100). On the other hand, if KF2 is a characteristic term “inbound” and the occurrence count ratio of KF2 is approximately 1% in the management information P(n−1) but it increases to 5% in the management information P(n), then the word score WFK1 derived from the equation (1) will be 400% (=5/1−1×100).

If the specified analysis range is the latest management information and past management information of the company, the word score is calculated for each real estate keyword based on the occurrence count thereof in the latest management information and the occurrence count thereof in the past management information. For example, if the analysis range is the latest management information P(n) and the immediately preceding past management information P(n−1) as shown in FIG. 4, the word score is calculated for each real estate keyword from the occurrence count in the latest management information P(n) and the occurrence count in the immediately preceding management information P(n−1).

In such a case, for example, the rate of increase in the ratio of the occurrence count relative to the total occurrence count of all real estate keywords may be used as a word score. According to this, a term with a higher occurrence count ratio relative to all real estate keywords is considered as more important, whereby the “importance increase rate”, which indicates how much the importance has increased from that of the immediately preceding management information, can be calculated as a word score.

The word score WFK1 of the real estate keyword FK1 in FIG. 4 will be described as a specific example. Where the ratio of the occurrence count of the real estate keyword FK1 to the total keyword occurrence count in the latest management information P(n) is RFK1(n)(=CFK1(n)/CFK1t(n)), and the ratio of the occurrence count of the real estate keyword FK1 to the total keyword occurrence count in the immediately preceding management information P(n−1) is RFK1(n−1)(=CFK1(n−1)/CFK1t(n−1)), the word score WFK1 can be calculated using the equation (1) below.

$$WFK 1 = ( RFK 1 ( n ) / RFK 1 ( n - 1 ) - 1 ) \times 100 \qquad ( 1 )$$

FIG. 5 shows a specific example of a display screen SCK1 that displays a result of such management information analysis. FIG. 5 is a diagram showing a specific example of the display screen SCK1 displayed on the terminal device 20. A keyword display field KS is displayed on the display screen SCK1. The keyword display field KS displays real estate keywords that indicate real estate utilization trends of a company. The real estate keywords in FIG. 5 are displayed with emphasis, for example, the higher the word score, the larger the font size. As shown in FIG. 5, for example, the keyword KF1 “inbound” with a word score WFK2 of 400% is displayed in a large font, whereas the keyword KF1 “sales” with a word score WFK1 of 0% is not displayed at all. Thus, keywords that have been frequently used in the past (such as “sales”, for example) can be excluded from display, and characteristic keywords that are rapidly increasing in importance (such as “inbound”, for example) can be displayed in a larger font than other words.

Thus, by calculating the word scores of real estate keywords using the latest management information P(n) and the immediately preceding management information P(n−1) as the analysis range, it is possible to display characteristic terms that are recently starting to be used more prominently than terms that are more likely to be used by companies, for example. As a result, a quick understanding of real estate utilization trends of the company becomes possible, making it easier to devise sales strategies. For example, in FIG. 5, words such as “vacant”, “real estate”, “anticipated”, and “inbound” are displayed larger and more prominently than other words. Therefore, it is possible to grasp at a glance that this company believes that inbound tourism can enable the utilization of vacant real estate. This understanding allows for the development of sales strategies that are highly likely to appeal to the company, such as plans tailored to inbound tourism demands.

It should be noted that the manner of emphasizing the display of real estate keywords is not limited to changing the font size as shown in FIG. 5. For example, the font or color of the words may be changed to emphasize the information. Furthermore, the display of real estate keywords is not limited to a word cloud-like display. For example, real estate keywords may be displayed in a list, with higher word scores being displayed at higher positions in the list.

The control unit 12 shown in FIG. 2 includes an information acquisition unit 121, an analysis range specification unit 122, an analysis unit 124, and an output unit 130. Each of these components of the control unit 12 may be configured as a physical circuit, or may be configured as a program executable by a CPU. The configuration of the control unit 12 is not limited to the configuration shown in FIG. 2.

The information acquisition unit 121 acquires management information of a plurality of companies from the management information server 30 via the communication unit 11. For example, the information acquisition unit 121 data-scrapes a management information providing site operated by the management information server 30, and acquires document data of management information of a plurality of companies. The information acquisition unit 121 can periodically crawl specific management information providing sites and automatically acquire document data of management information of various companies.

The information acquisition unit 121 stores the obtained management information directly into the management information database 143 if the information is in document data (PDF, XML, XBRL, or the like), which can be text-searched. If the document data cannot be text-searched (such as a PDF file in which the document is captured as an image), the information acquisition unit 121 converts the document data into text-searchable data and then stores it in the management information database 143. XBRL (eXtensible Business Reporting Language) is a report description language based on XML (eXtensible Markup Language).

It should be noted that document data of management information obtained through another route can also be added to the management information database 143 by the information acquisition unit 121. Specifically, the information acquisition unit 121 receives document data of management information in response to user operations from the terminal device 20 and adds the received data to the management information database 143. Thereby, for example, even when document data of management information of non-listed companies or non-public management information are acquired, such document data can still be added to the management information database 143.

The analysis range specification unit 122 specifies the analysis range of management information. The analysis range specification unit 122 specifies the analysis range of management information in response to an instruction from the user via the terminal device 20. For example, as an analysis range, the user can specify through the terminal device 20 the type of management information to be analyzed, such as mid-term management plans or securities reports, and the specific fiscal year or term of management information to be analyzed. Furthermore, management information for a desired fiscal year or term can be specified as an analysis range. As described above, past management information can also be specified along with the latest management information.

The analysis unit 124 analyzes the management information of each company acquired by the information acquisition unit 121 within the analysis range specified by the analysis range specification unit 122. Specifically, the analysis unit 124 counts the occurrences of real estate keywords such as those shown in FIG. 3 in each set of management information, and stores in the score database 145 word scores calculated based on the counted occurrences of the keywords.

The output unit 130 outputs display data for displaying a keyword display field containing real estate keywords of the company extracted by the analysis unit 124, as individual information for the company. Specifically, the output unit 130 generates and outputs display data for a keyword display field for displaying keywords that are emphasized according to the word scores calculated by the analysis unit 124. The display data is transmitted to the terminal device 20 via the communication unit 11. The terminal device 20 displays the keyword display field based on the display data. The display data may be Web screen data. Specifically, the information analysis device 10 displays the keywords on a Web screen. The terminal device 20 receives the Web screen data and displays it on a browser.

Next, a configuration example of the terminal device 20 will be described, with reference to FIG. 2. The terminal device 20 shown in FIG. 2 includes a communication unit 21, a control unit 22, a storage unit 24, an input unit 25, and a display unit 26. The communication unit 21, the control unit 22, the storage unit 24, the input unit 25, and the display unit 26 are each connected to a bus line 20L, and are capable of exchanging information (data) with one another.

The communication unit 21 is connected to the network N via a wired or wireless connection, and transmits and receives information (data) to and from the information analysis device 10. The communication unit 21 functions as a communication interface for the Internet or an intranet, and is capable of performing communication using, for example, TCP/IP, Wi-Fi (registered trademark), and Bluetooth (registered trademark).

The control unit 22 comprehensively controls the entire terminal device 20. The control unit 22 is composed of an integrated circuit such as an MPU (Micro Processing Unit). The control unit 22 includes a CPU (Central Processing Unit), a RAM (Random Access Memory), and a ROM (Read Only Memory). The control unit 22 loads necessary programs into the ROM and performs various processes by executing these programs using the RAM as a work area.

The storage unit 24 is an example of a storage medium (a tangible computer-readable storage medium) that stores various programs and data used by these programs executed by the control unit 22. The storage unit 24 stores various programs and data used by these programs executed by the control unit 22. The storage unit 24 is configured with a storage device such as a hard disk or an optical disk. The configuration of the storage unit 24 is not limited to these examples, and the storage unit 24 may be configured with a semiconductor memory such as a RAM or a flash memory. For example, the storage unit 24 can be configured as an SSD (Solid State Drive).

The input unit 25 includes a keyboard, a mouse, and so forth, and accepts an operation input from the user and transmits to the control unit 22 a control signal corresponding to the operation content. The input unit 25 may include a touch panel.

The display unit 26 is a liquid crystal display, an organic EL display, or the like, and displays various information according to instructions from the control unit 22. The control unit 22 displays a company list of potential client company candidates on the display unit 26 based on the display data received from the information analysis device 10 via the communication unit 21.

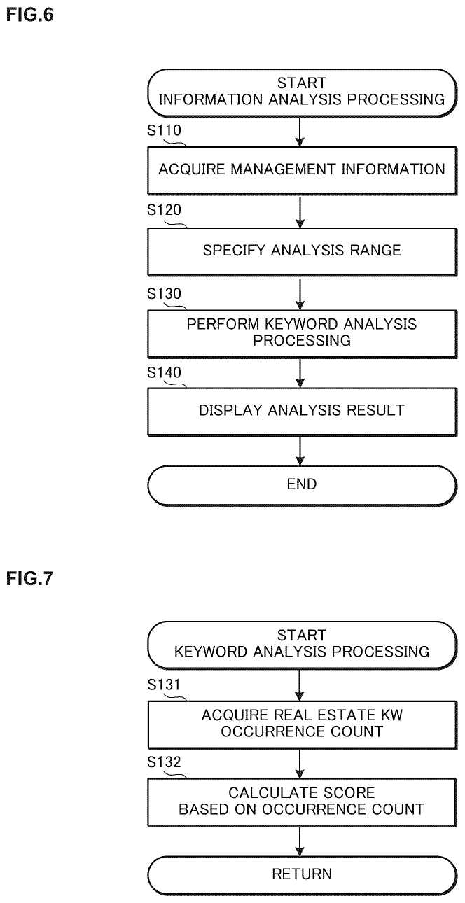

Next, the information analysis processing of a first function performed by the information analysis device 10 according to the first embodiment will be described, with reference to FIG. 6. The first function is a function for displaying keywords that enables a grasp of real estate utilization trends of a company by analyzing management information, using real estate keywords relevant to real estate utilization. FIG. 6 is a flowchart showing a specific example of the information analysis processing. The information analysis processing is executed by the control unit 12 (information acquisition unit 121, analysis range specification unit 122, analysis unit 124, output unit 130, and so forth) reading out necessary programs from the program storage unit 141.

First, in Step S110 shown in FIG. 6, the control unit 12 acquires management information of each company. Specifically, the information acquisition unit 121 acquires document data of management information of each company from the management information server 30 via the communication unit 11 and stores the document data in the management information database 143. The information acquisition unit 121 stores the obtained management information directly into the management information database 143 if the information is in document data (PDF, XML, XBRL, or the like containing text), which can be text-searched. If the document data cannot be text-searched (such as a PDF file in which the document is captured as an image), the information acquisition unit 121 converts the document data into text-searchable data and then stores it in the management information database 143.

Next, in Step S120, the control unit 12 specifies the analysis range of the management information. Specifically, the analysis range specification unit 122 specifies the analysis range based on preset information. For example, the latest management information (most recent management information) and the immediately preceding management information (past management information) as described above are set as the analysis range by default. It should be noted that the specification of the analysis range is not limited to the default setting.

For example, analysis range specification information set by a user on the terminal device 20 may be used. In such a case, for example, in terminal device 20, the analysis range may be flexibly set. This includes not only choosing to use only the latest management information as the analysis range or choosing to use both the latest management information and past management information as the analysis range, but also specifying the type of management information to be analyzed or the fiscal year or term of management information to be analyzed. Accordingly, the information acquisition unit 121 acquires specification information of the analysis range set by the user from the terminal device 20, and the control unit 12 sets the analysis range based on the acquired specification information. The analysis range specification unit 122 specifies the analysis range based on the set information.

Next, in Step S130, the control unit 12 performs keyword analysis processing. Specifically, the analysis unit 124 performs the keyword analysis processing on the management information acquired by the information acquisition unit 121. This keyword analysis processing is performed on the management information within the specified analysis range. The management information acquired by the information acquisition unit 121 is analyzed as the latest management information. When not only the latest management information but also past management information are specified as the analysis range, the control unit 12 reads out the past management information of the company from the storage unit 14 and performs the keyword analysis processing. The keyword analysis processing is performed as shown in FIG. 7, for example.

FIG. 7 is a flowchart showing a specific example of the keyword analysis processing. In the keyword analysis processing, first, in Step S131, the analysis unit 124 counts the occurrences of real estate keywords (real estate KW) in the document data of the management information within the specified analysis range. Next, in Step S132, the analysis unit 124 calculates word scores based on the counted occurrences, and stores the word scores in the score database 145. This word scores are results of the keyword analysis.

Next, in Step S130 shown in FIG. 6, the control unit 12 causes the terminal device 20 to display the results of the keyword analysis. Specifically, the output unit 130 generates display data and transmits it to the terminal device 20, whereby keywords are displayed in emphasized manner according to the word scores. For example, the output unit 130 generates display data such that the higher the word score, the larger the word. The process of Step S140 may be executed by the output unit 130 upon receiving a display request from the terminal device 20. The processes of Steps S110 to Step S140 are executed in response to a request from the terminal device 20. The process of Step S110 may be automatically executed by periodically crawling specific management information providing sites.

According to the information analysis device 10 of the first embodiment described above, it is possible to highlight keywords more distinctively than, for example, those frequently used by the company by acquiring the management information of a company and performing the keyword analysis upon specifying the analysis range. As a result, the true trends of company real estate utilization identified from the management information can be visualized using keywords. Thereby, without relying on the experience and intuition of skilled sales representatives, it is possible to develop strong real estate sales strategies for the company, and by presenting plans tailored to the company's needs, it is possible to increase the success rate of sales. Furthermore, keywords can be displayed so that the real estate utilization trends of the company can be grasped at a glance, significantly reducing the time and effort required for strategy development and making sales activities more efficient.

Moreover, the analysis range specification unit 122 includes not only the current management information but also the past management information in the analysis range, whereby the analysis unit 124 extracts as the latest keyword, from among the keywords contained in the management information of the company acquired by the information acquisition unit 121, keywords that are not contained in the past management information of the company. The reason for this is that management information of the same company is often issued regularly in a similar format, and thus utilizing past management information from the same company enables efficient extraction of its latest keywords. For example, as the current and past management information, the entire management information such as management plans and securities reports may be compared, or specific items may be compared. The fact that this is possible is also one of the features of the present invention when making use of management information, which is often regularly published in the same format for the same company. This allows for a significant improvement in the accuracy of extracting the latest keywords of the company, compared to extracting the latest keywords from social media, websites, and so forth. For example, when comparing specific items of management information, the analysis range specification unit 122 may search for items that contain real estate keywords and compare the items found in the search. The latest keywords here may be real estate keywords or hot keywords, which will be described later. By performing a comparative analysis similar to that in the case of real estate keywords described above, the latest hot keywords can also be extracted from the management information. In the case of hot keywords, the above real estate keywords may be replaced with hot keywords. Moreover, the output unit 130 can output display data for displaying the latest keyword in priority to other keywords. Accordingly, it is possible to prioritize the display of the latest topical keywords in the management information (for example, by raising their positions in the display order or emphasizing them).

In such a case, the output unit 130 may output display data that changes the font size depending on the occurrence count of the keywords, and displays the latest keywords in font sizes larger than those of keywords contained in the past management information. This makes the latest keywords more prominent, and the trending topics in the management information can be grasped at a glance as a result.

The analysis unit 1214 may separately extract real estate keyword contained in the management information acquired by the information acquisition unit 121 and real estate keyword contained in the past management information, and the output unit 150 may output display data for displaying, in the first keyword display field KS1, the real estate keyword contained in the past management information in addition to the real estate keyword contained in the management information acquired by the information acquisition unit 121. According to this, the past real estate keywords and the latest real estate keywords can be compared, and it is therefore possible to grasp at a glance trend changes in real estate utilization trends of the company.

### Second Embodiment

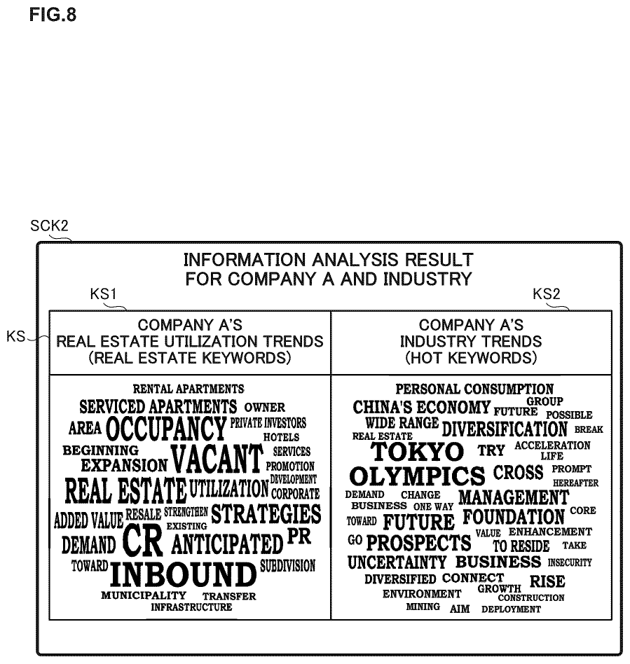

Hereunder, a second embodiment of the present invention will be described. In each of the modes exemplified below, components having substantially the same functional configuration are denoted by the same reference signs and redundant description will be omitted. The first embodiment exemplified the first function for displaying the real estate utilization trends of a company using real estate keywords as shown in FIG. 5, whereas the second embodiment will exemplify a second function for displaying the trends in the company's industry, using hot keywords as shown in FIG. 8. The second function is a function for displaying keywords that enables a grasp of industry trends of a company by analyzing management information using hot keywords relevant to environmental trends surrounding the company. The hot keywords here are keywords relevant to the environmental trends surrounding the company.

The analysis unit 124 of the second embodiment separately analyzes and extracts real estate keywords and hot keywords from keywords contained in the management information acquired by the information acquisition unit 121. The keyword display field of the second embodiment includes a first keyword display field KS1 that contains real estate keywords extracted by the analysis unit 124 and a second keyword display field KS2 that contains hot keywords.

FIG. 8 is a diagram showing a specific example of a display screen SCK2 displayed on the terminal device 20 in the second embodiment. In FIG. 8, the first keyword display field KS1 containing real estate keywords indicating the real estate utilization trends of the company in FIG. 5 and the second keyword display field KS2 containing hot keywords indicating the industry trends of the company are displayed in parallel. As with real estate keywords, hot keywords are displayed in different font sizes depending on their word score. Accordingly, not only the trends in real estate utilization of the company but also the trends in the industry (environmental trends) of the company can be grasped at a glance, making it clear why the company has those trends in real estate utilization. As a result, a deeper understanding of the real estate utilization trends of the company becomes possible, making it easier to develop sales strategies that deeply resonate with the company.

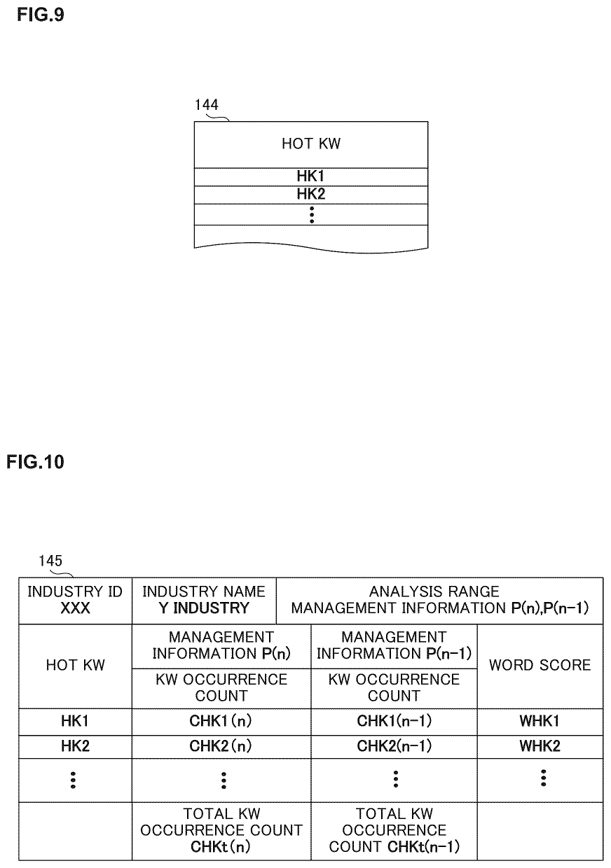

The keyword database 144 of such second embodiment stores not only real estate keywords (real estate KW) as shown in FIG. 3 but also hot keywords (hot KW) as shown in FIG. 9. FIG. 9 is a diagram showing a configuration example of a data table for hot keywords. As shown in FIG. 9, the keyword database 144 stores hot keywords such as FH1, FH2, . . . , and so on. The hot keywords are keywords relevant to the environmental trends surrounding the company. The keyword database 144 stores a plurality of hot keywords. The hot keywords may be categorized by industry and stored in the keyword database 144. The configuration of the hot keyword data table is not limited to that shown in FIG. 9.

The hot keywords FH1, FH2, . . . , and so on here preferably include keywords relevant to environmental trends surrounding the company. For example, as the hot keywords, keywords that enables a grasp of industry trends, such as keywords that are currently trending in the industry or society, are set. Displaying hot keywords that reflect the industry and societal trends enables an understanding of the environment surrounding the potential client company based on the hot keywords. Examples of such hot keywords FH1, FH2, . . . , and so on include “Tokyo Olympics”, “management foundation”, “future prospects”, “uncertainty”, and “diversification” as shown in FIG. 8.

However, simply extracting these hot keywords doesn't clearly suggest which keywords are crucial for grasping trends in the industry and society. This is because hot keywords that indicate environmental trends surrounding the company based on management information, as with the real estate keywords described above, often consist of frequently used terms, making characteristic terms less prominent and less noticeable.

Therefore, for hot keywords also, an analysis range of management information is specified, enabling analysis range specification of not only the latest management information but also past management information. Based on this, comparing with past data enables an analysis of keywords in the latest management information, and it is thus possible to lower the word score even for terms that appear frequently in the latest management information but also in the past management information, for example. As a result, it becomes possible, for example, to display recently introduced characteristic terms in larger font sizes compared to terms commonly used by the company or industry every term.

Thus, by specifying the analysis range and performing keyword analysis on management information of a company, it becomes possible to visually highlight characteristic keywords among the keywords relevant to the environmental trends surrounding the company, thereby enabling a quick understanding of the environmental trends surrounding the company and industry, and facilitating the development of sales strategies.

The word scores of hot keywords obtained by analyzing management information within the analysis range specified in this manner are associated with each industry and stored in a score database 145. In the score database 145 of the second embodiment, in addition to the data table for each company as shown in FIG. 4, a data table for each industry as shown in FIG. 10 is stored.

FIG. 10 is a diagram showing a configuration example of a data table for storing word scores of hot keywords. FIG. 10 differs from FIG. 4 in that real estate keywords and their word scores are stored for each company in FIG. 4, whereas hot keywords and their word scores are stored for each industry in FIG. 10. In the score database 145 of FIG. 10, industry ID, industry name, analysis range, hot keywords (hot KWs), management information (such as mid-term management plans), and occurrence counts of those keywords (KWs occurrence counts) are associated and stored for each industry. The configuration of the data table for storing hot keywords is not limited to that shown in the figure.

FIG. 10 illustrates an example in which management information P(n) and management information P(n−1) are specified as the analysis range. FH1, FH2, . . . , and so on are hot keywords (hot KW) of FIG. 9. CHK1(n), CHK2(n), . . . , and so on are the occurrence counts of the hot keywords FH1, FH2, . . . , and so on in the case of the management information P(n), respectively. CHK1(n−1), CHK2(n−1), . . . , and so on are the occurrence counts of the hot keywords FH1, FH2, . . . , and so on in the case of the management information P(n−1), respectively. WHK1, WHK2, . . . , and so on are the word scores of the hot keywords FH1, FH2, . . . , and so on, respectively.

The word score is calculated for each hot keyword and used, for example, to determine the keyword display (such as font size) as an industry trend. The keyword occurrence count (KW occurrence count) of FIG. 10 is an occurrence count of each hot keyword contained in the management information, and the total keyword occurrence count (such as CFKt(n)) is the sum of the occurrence counts of all hot keywords.

The word scores are calculated for each industry based on the occurrence counts of hot keywords in management information within a specified analysis range. The analysis range in the first embodiment is the management information of each company, which differs from the analysis range in the second embodiment being the management information of each industry, that is, the management information of multiple companies in an industry. The analysis unit 124 of the second embodiment analyzes and extracts hot keywords associated with the industry from the management information within the analysis range. Thus, the analysis range for hot keywords encompasses not only the management information of an individual company but the management information of multiple companies within an industry including the company, and it is therefore possible to efficiently acquire hot keywords for an entire industry, encompassing not only the company itself but also other companies within the industry.

As with the first embodiment, the word scores in the second embodiment also vary depending on the analysis range specified. For example, if the specified analysis range is only the latest management information of the industry, the occurrence count of each hot keyword contained in the latest management information becomes the word score. At this time, for example, the word score may be a value obtained by multiplying the occurrence count by a weighting factor. In such a case, the weighting factor may be adjusted so that the word score is lowered for a hot keyword that has appeared frequently in past management information. This makes it possible to visualize newer and more characteristic terms in the latest management information in a more prominent manner than terms frequently used in past management information.

If the specified analysis range is the latest management information and past management information of the company, the word score is calculated for each hot keyword based on the occurrence count thereof in the latest management information and the occurrence count thereof in the past management information. For example, if the analysis range is the latest management information P(n) and the immediately preceding past management information P(n−1) as shown in FIG. 4, the word score is calculated for each hot keyword from the occurrence count in the latest management information P(n) and the occurrence count in the immediately preceding management information P(n−1).

In such a case, for example, the rate of increase in the occurrence count ratio relative to the total occurrence count of all hot keywords may be used as a word score. According to this, a term with a higher occurrence count ratio relative to all hot keywords is considered as more important, whereby the “importance increase rate”, which indicates how much the importance has increased from that of the immediately preceding management information, can be calculated as a word score.

The word score WHK1 of the hot keyword FHK1 in FIG. 10 will be described as a specific example. Where the ratio of the occurrence count of the hot keyword FHK1 to the total keyword occurrence count in the latest management information P(n) is RHK1(n)(=CHK1(n)/CHK1t(n)), and the ratio of the occurrence count of the hot keyword FH1 to the total keyword occurrence count in the immediately preceding management information P(n−1) is RHK1(n−1)(=CHK1(n−1)/CHK1t(n−1)), the word score WHK1 can be calculated using the equation (2) below.

$$WHK 1 ( RKH 1 ( n ) / RHK 1 ( n - 1 ) - 1 ) \times 100 \qquad ( 2 )$$

FIG. 8 shows a specific example of the display screen SCK2 that displays the results of calculating and analyzing the word scores WHK1, WHK2, . . . , and so on. FIG. 8 is a diagram showing a specific example of the display screen SCK2 according to the second embodiment. A keyword display field KS is displayed on the display screen SCK2 of FIG. 8. The keyword display field KS includes a first keyword display field KS1 and a second keyword display field KS2. The first keyword display field KS1 displays real estate keywords that indicate trends in real estate utilization of a company, and the second keyword display field KS2 displays hot keywords that indicate industry trends. As with the real estate keywords, the hot keywords in FIG. 8 are displayed with emphasis, for example, the higher the word score, the larger the font size.

As shown in FIG. 8, the first keyword display field KS1 and the second keyword display field KS2 are arranged side by side on the display screen SCK2. The positioning of the first keyword display field KS1 and the second keyword display field KS2 is not limited to the example shown in the figure, and they may be arranged vertically, for example. Thus, real estate keywords indicating the real estate utilization trends of a company and hot keywords indicating the industry trends of the company are displayed side by side, and it is therefore possible to grasp at a glance the real estate utilization trends of the company and the environmental trends surrounding its industry, making it also easier to grasp the rationale behind the company's real estate utilization trends. For example, in the second keyword display field KS2 in FIG. 8, the word “Tokyo Olympics” is displayed large in the industry trend field, and therefore it is also easy to grasp the reason for the word “inbound” of the company being displayed large in the first keyword display field KS1. As a result, a deeper understanding of the real estate utilization trends of the company becomes possible, making it easier to devise sales strategies that deeply resonate with the company.

The manner of emphasizing the display of hot keywords is not limited to changing the font size as shown in FIG. 8. For example, the font or color of the words may be changed to emphasize the information. Moreover, the display of hot keywords is not limited to this example. For example, hot keywords may be displayed in a list, with higher word scores being displayed at higher positions in the list.

The information analysis processing of the second function performed in the second embodiment is the same as that shown in FIG. 6 and FIG. 7. By appropriately replacing the readings, such as replacing the reading of “real estate keywords” with that of “hot keywords”, in FIG. 6 and FIG. 7, the processing of FIG. 6 and FIG. 7 can also be applied to the second embodiment. When applying the processing of FIG. 6 and FIG. 7, the analysis range of the second embodiment is management information of each industry, that is, management information of multiple companies in the industry, as described above.

### Third Embodiment

Hereunder, a third embodiment of the present invention will be described. The third embodiment will exemplify a third function in which the management information of multiple companies is analyzed, whereby a list of potential client company candidates likely to engage in real estate transactions is displayed on the terminal device 20. The first function is a function for displaying a list of potential client company candidates by analyzing management information using specific keywords relevant to real estate transactions. According to such a function, among the companies listed in the potential client company candidate list, the individual information of a company specified by hovering the cursor over or clicking on the company (such as real estate keywords indicating the real estate utilization trends of the company and hot keywords indicating industry trends) can be displayed on the same screen of the terminal device 20.

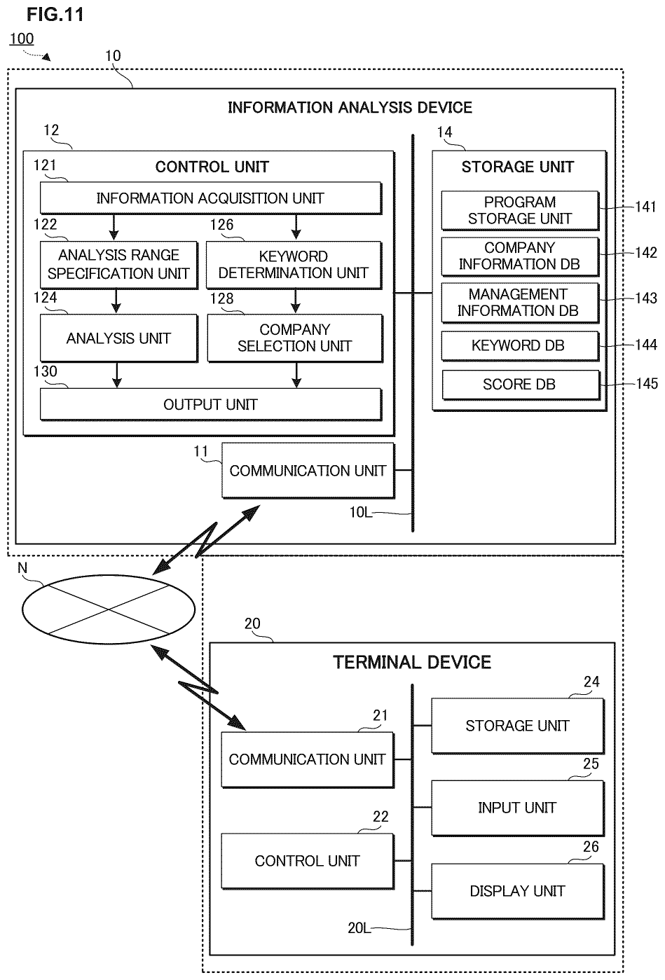

An information analysis device 10 of such third embodiment will be described below, with reference to the drawings. FIG. 11 is a block diagram showing a specific configuration example of the information analysis device according to the third embodiment. FIG. 11 differs from FIG. 2 in that a keyword determination unit 126 and a company selection unit 128 are provided in the control unit 12. A keyword database 144 (keyword DB) of the third embodiment stores specific keywords and weighting factors.

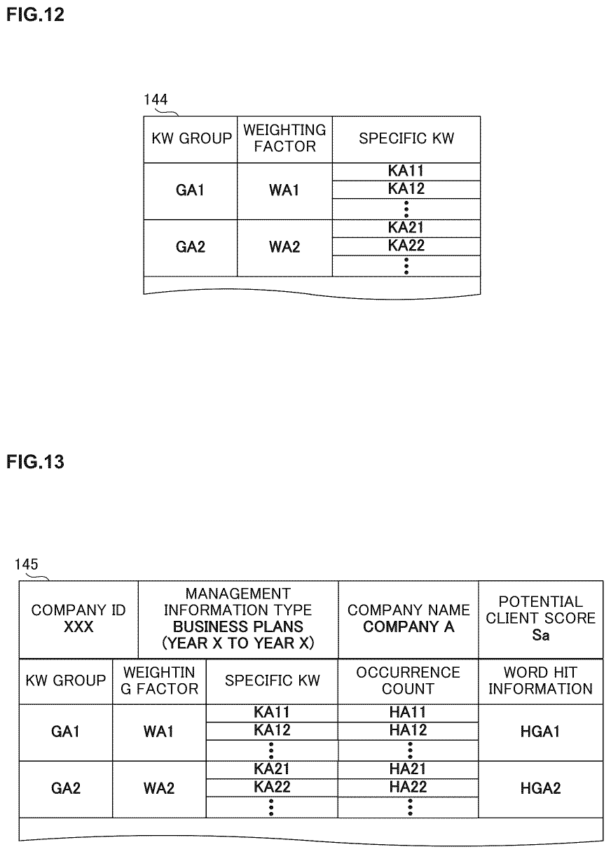

FIG. 12 is a diagram showing a configuration example of a data table for storing specific keywords. The specific keywords here are keywords relevant to real estate transactions, and are used to select potential client company candidates likely to have demand for real estate transactions. For example, by setting specific keywords that might appear in the management information of companies with real estate transaction demand (such as demand and potential demand for buying, selling, or renting real estate, for example), it is possible to select companies with a high success rate of sales.

Examples of such specific keywords include “trend forecasting keywords” for forecasting trends in the real estate transactions of a company, “key person keywords” for finding companies with executives who are likely to understand the need for real estate liquidation, and “facility status keywords” for finding companies that own real estate or facilities likely to have demand for real estate transactions.

In FIG. 12, multiple specific keywords are divided into several keyword groups GA1, GA2, . . . , and so on, and the keyword groups GA1, GA2, . . . , and so on are stored in association with weighting factors WA1, WA2, . . . , and so on, respectively. Examples of the keyword groups GA1, GA2, . . . , and so on include “efficiency keywords” related to asset efficiency, and “financial keywords” related to financial improvements. Examples of the “efficiency keywords” include specific keywords such as “asset efficiency” mentioned above. Examples of the “financial keywords” include “interest-bearing debt reduction”. By setting a weighting factor for each of these keyword groups, it is possible to associate the weighting factor with corporate management characteristics related to real estate transactions.

For example, the weighting factor of the keyword group GA1 is WA1, and the weighting factor of the keyword group GA2 is WA2. For example, if the occurrence of a specific keyword of the keyword group GA2 in the management information is more likely to result in sales success than the occurrence of a specific keyword of the keyword group GA1, the weighting factor WA2 is set to be greater than the weighting factor WA1. This allows for the analysis of management information that reflects the high level of interest in real estate transactions from the corporate management knowledge related to real estate transactions, thereby making it easier to select promising companies as potential clients.

The score database 145 stores the occurrence counts of specific keywords associated with each set of management information for each company and potential client scores (index values). The potential client score is calculated for each set of management information and is used, for example, as approach information for selecting potential client company candidates and determining their display order. The potential client score is calculated based on the occurrence count of a specific keyword in each keyword group and a weighting factor. Specifically, the potential client score is calculated from word hit information obtained from the occurrence count of a specific keyword for each keyword group and a weighting factor. The word hit information is a set of information that serves to indicate the occurrence frequency of each specific keyword from a keyword group (how many hits each specific keyword has) in management information, for each keyword group. The word hit information indicates how often a specific keyword from a keyword group appears in management information.

The word hit information is, for example, the sum of the total occurrence counts of all specific keywords included in a keyword group. However, the invention is not limited to this example, and if any specific keyword from a keyword group is found in management information, the word hit information may be set to 1 (hit), for example. Moreover, the word hit information may be a normalized or standardized numerical value of the occurrence count of each specific keyword from a keyword group.

Thus, by calculating a potential client score from the word hit information and weighting factor of each keyword group, the potential client score can be adjusted depending on the occurrence frequency of a specific keyword from each keyword group in management information. In this respect, the potential client score can also be interpreted as a word coverage rate of a specific keyword. By listing such potential client company candidates in order of high potential client scores, it is possible to display a list of companies in descending order of likelihood of sales success.

Here, a configuration example of the data table for storing such potential client scores will be described, with reference to FIG. 13. The data table of FIG. 13 is stored in the score database 145. A case of analyzing company A's management plan, acquired as management information, using the specific keywords of FIG. 12 will be described as an example. The configuration of the data table for storing potential client scores is not limited to the example shown in the FIG. 13.

The data table of FIG. 13 stores the occurrence counts HA11, HA12, . . . , and so on of specific keywords (specific KWs) used to analyze the management plan of company A, and potential client scores Sa. The data table of FIG. 13 stores various information, including basic information found in management plans such as company ID, management information type, and company name, keyword groups used for management information analysis, weighting factors, and specific keywords.

The occurrence count HA11 in FIG. 13 is the occurrence count of a specific keyword KA11 from a keyword group (KW group) GA1, and the occurrence count HA21 is the occurrence count of a specific keyword KA21 from a keyword group GA2. The word hit information of each keyword group is in FIG. 13 is, for example, the sum of the total occurrence counts of all specific keywords from a keyword group. For example, HGA1 is the sum of all occurrence counts HA11, HA12, . . . , and so on of the specific keywords from the keyword group GAL. Where the number of keyword groups in FIG. 13 is n, the potential client score Sa can be expressed by the equation (3) below, based on the word hit information HGA1 to HGAn and the weighting factors WA1 to WAn. However, the equation for calculating the potential client score Sa is not limited to the following equation (3).

$$Sa = HGA 1 \times WA 1 + HGA 2 \times WA 2 + ⋯ + HGAn \times WAn \qquad ( 3 )$$

The weighting factor for each keyword group can be set freely. For example, an experienced sales representative can preliminarily set the weighting factors based on their own expertise to ensure that the management information of a promising potential client company that is more likely to have demand for real estate transactions will have a higher potential client score. As described above, in the third embodiment, by grouping specific keywords according to common characteristics and setting weighting factors in advance, it is possible to reflect the characteristics and importance of corporate management ideas in the potential client score of management information. This enables acquisition of a potential client score based on the potential demand for real estate transactions.

As shown in FIG. 11, the keyword determination unit 126 of the third embodiment performs specific keyword determination processing to determine whether or not the management information acquired by the information acquisition unit 121 contains a specific keyword from the keyword database 144, and acquires a potential client score as a result of the management information analysis. The keyword determination unit 126 reads out the document data of management information from the management information database 143 and performs a specific keyword determination. The keyword determination unit 126 performs the specific keyword determination processing on each set of management information acquired by the information acquisition unit 121, counts the occurrence of the specific keyword from each keyword group, and stores the occurrence count of the keyword in the score database 145.

The keyword determination unit 126 acquires the potential client score as a result of the management information analysis based on the specific keyword determination processing. Specifically, the keyword determination unit 126 calculates and acquires the potential client score from the management information, based on the occurrence count and weighting factor of a specific keyword from each keyword group. The keyword determination unit 126 stores the acquired potential client score in the score database 145 in association with the management information.

The company selection unit 128 selects as a potential client company candidate a company determined by the keyword determination unit 126 as containing a specific keyword in the management information. The potential client scores of management information described above are used for potential client company candidate selection. For example, the company selection unit 128 selects companies as potential client company candidates if their potential client scores from management information stored in the score database 145 exceeds a predetermined threshold value. This enables the adjustment of the number of potential client company candidates by adjusting the above predetermined threshold value, thereby suppressing an excessive rise in potential client company candidates with low potential client scores, for example.

If there are no specific keywords in management information, the potential client score will be zero because there are no occurrences of specific keywords, and the potential client score for management information containing at least one specific keyword will be 1 or higher. Thus, if there are few potential client company candidates, for example, companies with a potential client score of management information exceeding a threshold value of 1 may be selected as potential client company candidates. This allows companies that contain at least one specific keyword to be selected as potential client company candidates, thereby increasing the number of potential client company candidates.

The output unit 130 generates and outputs display data for displaying a company list of potential client company candidates selected by the company selection unit 128. The output unit 130 generates and outputs display data for displaying a list of companies in descending order of potential client scores of management information. The display data is transmitted to the terminal device 20 via the communication unit 11. The terminal device 20 displays the potential client company candidate list based on the display data. The display data may be Web screen data. Specifically, the information analysis device 10 displays the potential client company candidate list on a Web screen. The terminal device 20 receives the Web screen data and displays it on a browser.

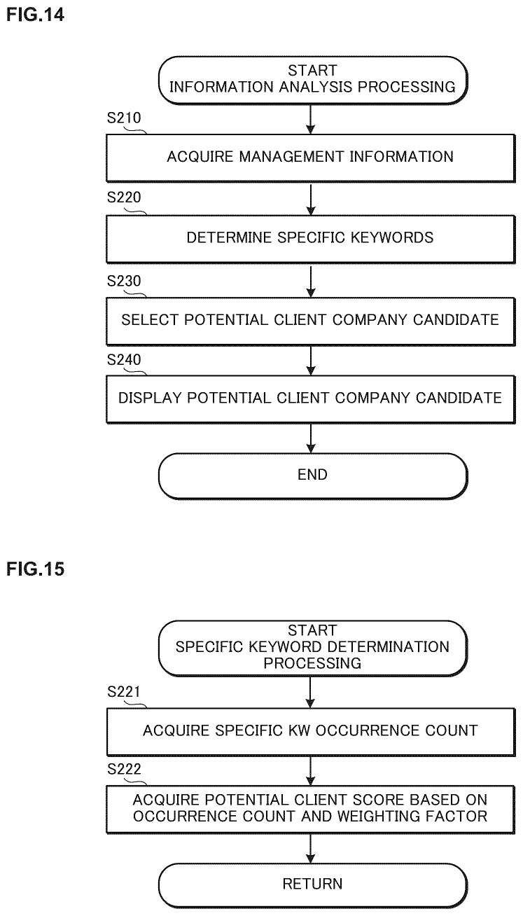

Next, information analysis processing of the third function performed by the information analysis device 10 according to the third embodiment will be described, with reference to FIG. 14. FIG. 14 is a flowchart showing a specific example of the information analysis processing. The information analysis processing is executed by the control unit 12 (information acquisition unit 121, keyword determination unit 126, company selection unit 128, output unit 130, and so forth) reading out necessary programs such as an information analysis program from the program storage unit 141.

First, in Step S210 shown in FIG. 14, the control unit 12 acquires management information of each company. The process of Step S210 is the same as that of Step S110 of FIG. 6, and therefore, the detailed description thereof will be omitted. Next, in Step S220, the control unit 12 performs specific keyword determination process on each set of document data of management information acquired by the information acquisition unit 121. In the specific keyword determination, whether or not a specific keyword from each keyword group is contained in the document data of the management information is determined, and the occurrence count of the specific keyword and the potential client score of that management information are acquired. The specific keyword determination process is performed as shown in FIG. 15, for example.

FIG. 15 is a diagram showing a specific example of the specific keyword determination processing. In Step S221 shown in FIG. 15, the control unit 12 acquires the occurrence count of each specific keyword (specific KW) for each keyword group. Specifically, the keyword determination unit 126 reads out document data of management information from the management information database 143, determines whether or not the document data contains a specific keyword associated with each keyword group in the keyword database 144, and counts the occurrence of the specific keyword. The keyword determination unit 126 stores the counted occurrences in the score database 145 in association with the management information.

Next, in Step S222, the control unit 12 calculates a potential client score for the management information based on the occurrence count and weighting factor of the specific keyword associated with the management information. Specifically, the keyword determination unit 126 calculates a potential client score based on the word hit information obtained from the occurrence count of the specific keyword and a weighting factor for each keyword group, and stores the score in the score database 145 in association with the management information. The calculation of the potential client score in Step S222 is performed for all the document data of management information acquired by the information acquisition unit 121. The potential client scores represent the results of the management information analysis based on the specific keyword determination processing.

Next, in Step S230 shown in FIG. 14, the control unit 12 selects potential client company candidates from the results of the management information analysis based on the specific keyword determination processing. Specifically, the company selection unit 128 selects companies as potential client company candidates if their potential client scores from management information stored in the score database 145 exceeds a predetermined threshold value. The process of Step S230 is performed on the potential client scores of the latest management information for all companies stored in the score database 145. As a result, it is possible to always select potential client company candidates from the latest management information.

Next, in Step S240, the control unit 12 causes the terminal device 20 to display the companies selected in Step S230. Specifically, the output unit 130 generates display data and transmits it to the terminal device 20, thereby causing the terminal device 20 to display a list of companies selected by the company selection unit 128 as approach information. For example, the output unit 130 generates and outputs display data for displaying a company candidate display field LS so that the selected companies are displayed in descending order of their potential client scores. The process of Step S240 may be executed by the output unit 130 upon receiving a display request for approach information from the terminal device 20. On the other hand, the processes of Step S210 to Step S230 may be automatically executed by periodically crawling specific management management information providing sites, or executed upon request from the terminal device 20.

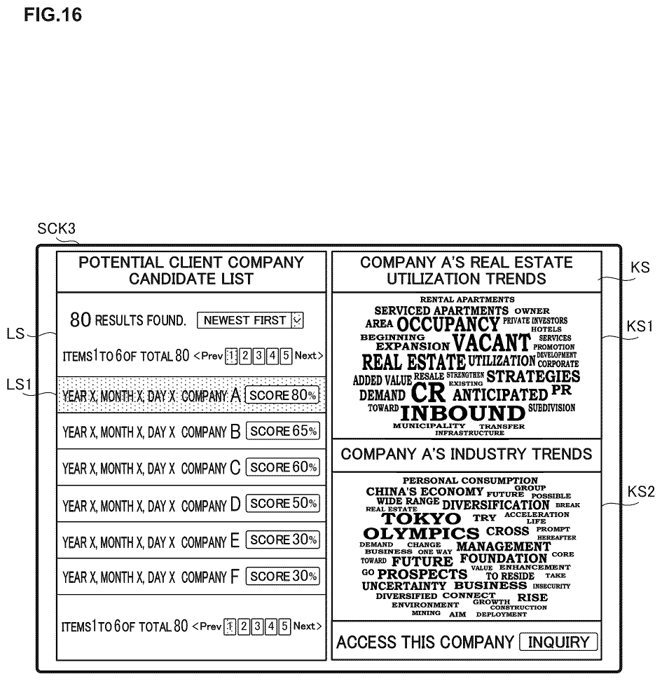

Here, a specific example of a display screen SCK3 displayed on the display unit 26 of the terminal device 20 is shown in FIG. 16. FIG. 16 is a diagram showing a specific example of the display screen SCK3 according to the third embodiment. A company candidate display field LS and a keyword display field KS are displayed on the display screen SCK3, and a first keyword display field KS1 and a second keyword display field KS2 are displayed in the keyword display field KS. The first keyword display field KS1 displays real estate keywords that indicate trends in real estate utilization of a company, and the second keyword display field KS2 displays hot keywords that indicate industry trends.

In FIG. 16, when the display screen SCK3 is viewed from the front, the company candidate display field LS is arranged on the left side, and the keyword display field KS is arranged on the right side. The first keyword display field KS1 and the second keyword display field KS2 are arranged vertically for display. The positioning of the company candidate display field LS, the first keyword display field KS1, and the second keyword display field KS2 is not limited to the example shown in the figure, and they may be arranged in any manner.

In the company candidate display field LS, a potential client company candidate list is displayed as approach information. In this potential client company candidate list, companies with higher scores are displayed at higher positions in the list. As a result, companies with a higher likelihood of sales success can be ranked higher for display. The company candidate display field LS displays the number of potential companies (for example, 80 results found), page switching buttons, and so forth. Each of individual company display fields LS1 displayed in the list displays, for example, “date”, “company name”, and “potential client score”. It should be noted that the display items are not limited to those shown in the figure, and items such as “stock code”, “listing market”, “capitalization”, “industry sector”, “business type”, “employee count”, “financial closing date”, “location”, “business particulars”, and “remarks” may be added. Also, a search period field in which input of a period can be made may be provided, thereby refining the display to companies selected through the management information analysis performed within the input period.

The output unit 130 of the third embodiment generates and outputs display data that displays a specified potential client company candidate in an emphasized manner within the company candidate display field LS, as shown in FIG. 16. Moreover, the display data also arranges and displays individual information of the specified potential client company candidate (including real estate keywords indicating the real estate utilization trends of the company) alongside the specified potential client company candidate, within the company candidate display field LS. As a result, for example, a company is specified by clicking on or hovering the cursor over any of the companies listed in the company candidate display field LS, and the individual information of the specified company is then displayed therealongside within the company candidate display field LS.

Specifically, each company display field LS1 (individual company display frame) in FIG. 16 is a button, and when a company display field LS1 is clicked on with a mouse or the like of the input unit 25, the company is specified and emphasized (by changing the color, shading, changing the font, and so forth). Further, real estate keywords indicating the real estate utilization trends of the company are displayed in the first keyword display field KS1, and hot keywords indicating trends in the company's industry are displayed in the second keyword display field KS2. FIG. 16 is an example of the display when company A, located at the top of the individual company display fields LS1, is clicked, and accordingly, the first keyword display field KS1 displays real estate keywords that indicate trends in real estate utilization of company A, and the second keyword display field KS2 displays hot keywords that indicate trends of company A's industry. In FIG. 16 also, both real estate keywords and hot keywords are displayed with emphasis based on their word scores, with larger font sizes, for example, indicating higher word scores. The position and color of the keywords may be random, and the keywords may be displayed closer together as they occur more frequently together.

Then, when company B among the potential client company candidates on the display screen SCK3 in FIG. 16 is clicked, the first keyword display field KS1 displays real estate keywords that indicate trends in real estate utilization of company B, and the second keyword display field KS2 displays hot keywords that indicate trends of company B's industry. Also, an “inquiry” button may be displayed on the display screen SCK3 as shown in FIG. 16. As a result, on the same screen as the display screen showing the potential client company candidate list, real estate keywords, hot keywords, and so forth, it is possible to directly inquire about the company and their real estate information.

According to the third embodiment, the display not only lists potential client company candidates with a higher likelihood for real estate transactions but also shows keyword analysis information of each company therealongside. As a result, based on company management information, companies with potential real estate transaction demands are displayed as potential client company candidates, and even keywords relevant to real estate transactions and real estate utilization are visualized as individual information of the companies, and therefore, it is possible to grasp at a glance real estate transaction trends and utilization trends of the company, making it easy to develop real estate sales strategies for the company. Furthermore, when a potential client company candidate is specified, the individual information on the company is displayed. Specifically, by clicking on potential client company candidates one after another, it is possible to see keywords related to the real estate transaction and utilization trends of those companies one after another, which makes finding desired potential client company candidates easier.

In the third embodiment, the specific keyword determination processing (Step S220 in FIG. 14) has been illustrated an example in which a potential client score is calculated based on the occurrence count of specific keywords contained in management information document data and a weighting factor, however, the invention is not limited to this example. For example, the potential client score may be acquired using a preliminarily trained model developed through machine learning or artificial intelligence (AI).

### Fourth Embodiment

Hereunder, a fourth embodiment of the present invention will be described. The first embodiment exemplified the case where keywords indicating the real estate activity trends of a company are displayed as individual information of the company by means of the first function. The fourth embodiment will exemplify a case where a fourth function is used to display a potential client company candidate list, along with essential information for real estate properties of those companies and map information as individual information of those companies, as shown in FIG. 14.

The fourth function is a function to narrow down real estate property information in the management information of a company to specific essential information, analyze it, and display the essential information and map information. The “essential information” here refers to the minimal necessary information for finding real estate properties of companies.

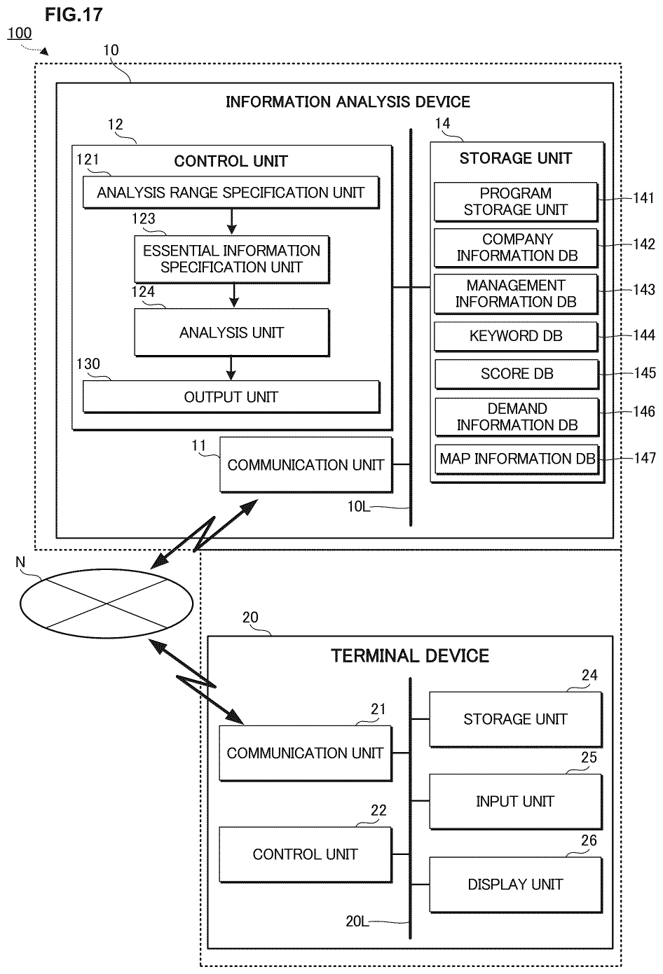

FIG. 17 is a block diagram showing a specific configuration example of an information analysis system 100 according to the fourth embodiment. The information analysis device 10 of FIG. 17 differs from that of FIG. 2 in that the control unit 12 has an essential information specification unit 123 to replace the analysis range specification unit 122, and that the storage unit 14 has a demand information database 146 (demand information DB) and a map information database 147 (map information DB).

Conventionally, when displaying real estate property information, the approach has been to display as much information as possible, facilitating the search for properties that cater to diverse needs. However, the more information there is about each property, the harder it is to find a genuinely necessary real estate. In particular, since the essential information needed to search for a commercial real estate owned by a company is limited, the more information displayed, the more difficult it becomes to find a desired property. Moreover, if available information is limited to information input by the real estate information provider, it is not possible to access real estate information that has not been input.

Therefore, in the fourth function, real estate property information in the management information of a company is narrowed down to specific essential information and displayed on the terminal device 20. As a result, the essential information needed to find a desired commercial real estate can be grasped at a glance, and the process of finding a genuinely necessary commercial real estate becomes easier. The “essential information” here refers to the minimal necessary information for finding a real estate property of a company. Such “essential information” includes at least the “location”, “use”, “use zone”, “land scale”, and “building scale” of real estate properties. For “location,” it is preferable to provide information about the prefecture and municipality at minimum. “Use” refers to the intended use of the real estate (asset), such as “factory” or “warehouse”. For “scale”, it is preferable to provide information about both “land scale” and “building scale”. These details are the minimal necessary important information for a user seeking a real estate of a company.

The “use zone” here refers to a region that regulates the use of buildings, building coverage ratio, floor area ratio, and so forth. There are 13 types of “use zones” including residential, commercial, and industrial zones. Examples of industrial zones include “factory zone”, “semi-factory zone”, and “exclusive industrial zone”. An “industrial zone” is a region designated primarily for the purpose of promoting industrial convenience, while a “semi-industrial zone” is a region designated primarily for the purpose of promoting industrial convenience that does not pose a risk of causing environmental degradation. An “exclusive industrial zone” is a region designated for the purpose of promoting industrial convenience. Thus, “use zone” is also important information for determining what kind of regulations exist for a real estate property.

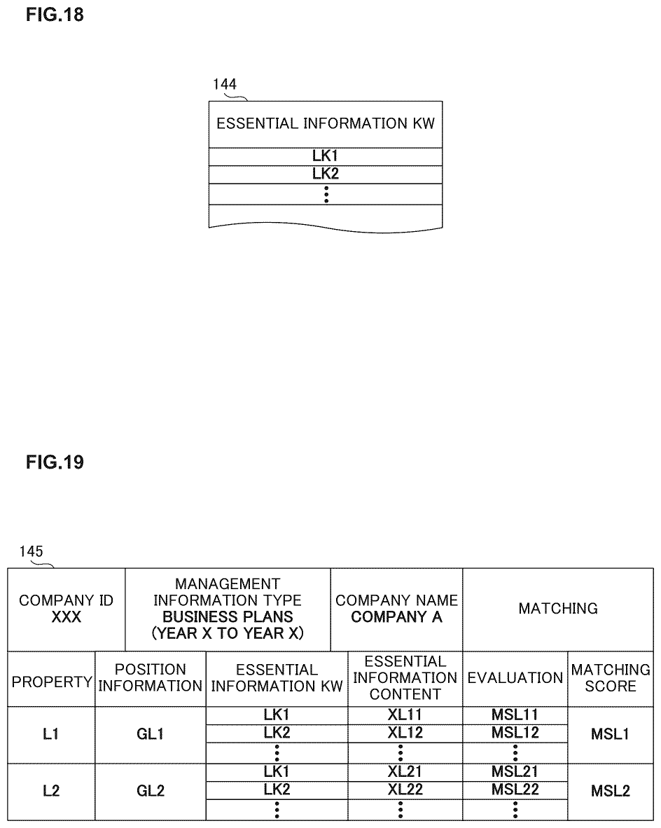

Essential information keywords used in the analysis of management information are stored in the keyword database 144. The essential information keywords are keywords used for acquiring specific essential information from management information. FIG. 18 is a diagram showing a configuration example of a data table for storing essential information keywords. Specific essential information keywords LK1, LK2, . . . , and so on are preliminarily set in the data table of FIG. 18. The configuration of the keyword database 144 is not limited to that shown in FIG. 18.

It is preferable that the essential information keywords be keywords that enable acquisition of the specific essential information mentioned above from management information. Examples of essential information keywords include “location”, “use”, “use zone”, and “scale”. “Location” refers to a keyword for acquiring at least the prefecture and municipality, and “use” is a keyword for acquiring the use of real estate, such as “factory” or “warehouse”. It is preferable to separate “scale” into “land scale” and “building scale”. As a result, it is possible to separately acquire information about land scale and building scale. “Use zone” refers to a keyword for acquiring the type of “use zone” of real estate as described above.

In the fourth embodiment, a description field containing essential information keywords for real estate properties is found from management information, by performing keyword analysis on the management information of a company, and the content of the essential information is acquired from the description field. It should be noted that it is not always necessary to use an essential information keyword to acquire essential information. When the description field for essential information of a real estate property, such as a securities report, is known in advance, the content of the essential information can be acquired from the description field. Also, essential information items may be changed or added by settings in the information analysis device 10 or operations from the terminal device 20. Essential information keywords can also be changed or added depending on the items that have been changed or added.

The essential information for real estate properties acquired from management information is stored for each company in the company information database 142 (company information DB). In the company information database 142, not only the essential information of real estate properties acquired from management information, but also the essential information for real estate properties input from the terminal device 20 may be stored. This enables inputs via the terminal device 20 from users wishing to offer real estate properties. In such a case, upon receiving essential information input from the terminal device 20, the information analysis device 10 stores the essential information in the company information database 142. Essential information for real estate properties is not limited to being stored in the company information database 142. For example, a property information database (property information DB) not shown in the drawings may be provided separately in the storage unit 14 to store essential information for real estate properties.

The demand information database 146 stores demand information of users who are seeking a real estate of a company. The demand information includes essential information (needs) of real estate properties sought by users. The demand information database 146 may store registration information such as user's name, company, email address, and password. A user seeking a real estate property can search the real estate properties of companies upon inputting and registering registration information on the terminal device 20. When searching for a real estate property of a company, the desired essential information for the property being sought is input from the terminal device 20. Upon receiving the essential information from the user seeking a real estate property via the terminal device 20, the information acquisition unit 121 stores demand information containing the essential information for the real estate property into the demand information database 146.

The score database 145 stores matching scores (index values) obtained through matching analysis processing. FIG. 19 is a diagram showing a configuration example of a data table for storing the score database 145 (score DB). In the score database 145 of FIG. 19, company IDs, company names, management information types, properties, (real estate properties), location information (property location information), essential information keywords (essential information KW), and occurrence counts of those keywords (KW occurrence counts) are associated and stored for each company. The configuration of the database for storing matching scores is not limited to the example shown in the FIG. 19.

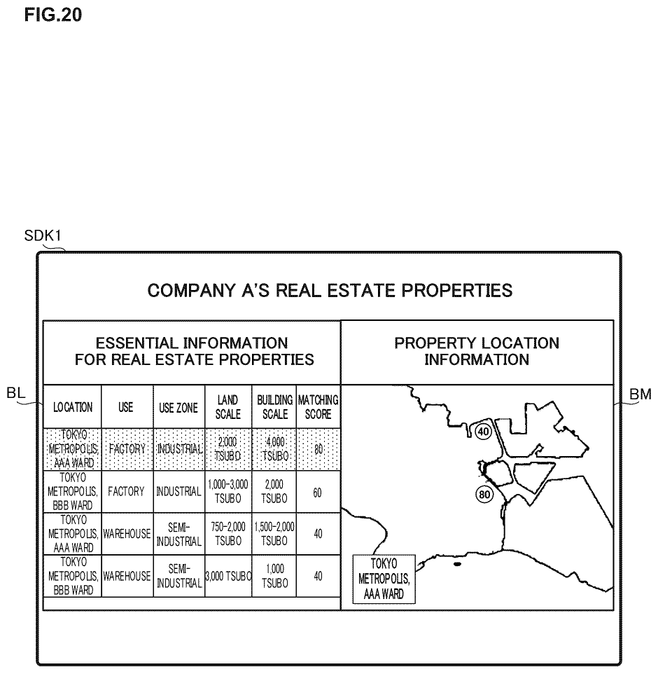

In FIG. 19, properties L1, L2, . . . , and so on are property IDs for identifying each property. Location information GL1, GL2, . . . , and so on are GPS information. The GPS information is acquired through the network N from the “location” information of properties in the acquired essential information. Essential information keywords LK1, LK2, . . . , and so on of FIG. 4 are the essential information keywords of FIG. 18, and the contents thereof are Xl11, XL, . . . , and so on, respectively. For example, in FIG. 20, there are only five sets of essential information for real estate properties, LK1 being “location”, LK2 being “use”, LK3 being “use zone”, LK4 being “land scale”, and LK5 being “building scale”. For the uppermost property, L1, the essential information contents thereof include XL11 being “Tokyo AAA Ward”, XL12 being “factory”, XL13 being “factory”, XL14 being “2,000 tsubo”, and XL15 being “4,000 tsubo”. The XL13 “factory” is a use zone type, meaning a “factory zone”. The “semi-industrial” of the second property, L2, refers to a “semi-industrial zone”.

The evaluation MSLs in FIG. 4 are evaluations of individual essential information and are used in the matching analysis processing. The matching analysis processing compares and analyzes essential information from a user seeking a real estate property, with essential information from real estate properties of companies, and an evaluation of “1” is given if the individual essential information matches, whereas an evaluation of “0” is given if it does not match. In FIG. 4, MSL1 is the matching score for property L1, and MSL2 is the matching score for property L2. For example, the matching score MSL1 of property L1 is calculated as shown in the following equation (4), where MA represents the number of sets of essential information when all essential information match, and MB represents the number of matched sets of essential information.

$$MSL 1 = ( MB / MA ) \times 100 \qquad ( 4 )$$

There are a total of five sets of essential information in FIG. 20, and therefore, MSL1 will be 20% if one essential information matches, 40% if two of them match, 60% if three of them match, 80% if four of them match, and 100% if five of them all match. The method of calculating the matching score is not limited to the above example.

The map information database 147 in FIG. 17 stores map information. The map information in the map information database 147 may be acquired from an external map server (not shown in the drawings) via the network N based on the locations of properties, or may be stored in the map information database 147 in advance. For example, when displaying the location of a property on the map as shown in FIG. 20, the digits in the matching score of the property may be overlaid and displayed on the position on the map based on the GPS information of the property.

FIG. 20 shows a specific example of a display screen SDK1 that displays such essential information for real estate properties acquired from management information. FIG. 20 is a diagram showing a specific example of the display screen SDK1 displayed on the terminal device 20. An essential information display field BL and a map information display field BM are displayed on the display screen SDK1. In the essential information display field BL, a list of real estate properties of companies with matching scores equal to or higher than a predetermined value is displayed, accompanied by essential information. Real estate properties are listed in descending order of their matching scores for display. For example, in FIG. 20, there are only five sets of essential information for real estate properties, the five sets of essential information being “location”, “use”, “use zone”, “land scale”, and “building scale”. The map information display field BM displays a map from the map information and matching scores overlaid on the locations of real estate properties on the map.

As shown in FIG. 20, the essential information display field BL and the map information display field BM are arranged side by side on the display screen SDK2. The positioning of the essential information display field BL and the map information display field BM is not limited to the example shown in the figure, and they may be arranged vertically, for example. Thus, displaying the essential information display field BL alongside the map information display field BM makes the information on real estate properties of the companies highly readable and comprehensible. This is because the property information is narrowed down to the minimal necessary essential information (only five in FIG. 20), making it much easier to read compared to displaying a lot of information. Also, by overlaying the matching scores on the locations on the map, properties that match the needs can be easily found at a glance by comparing them with the essential information.

The information acquisition unit 121 of the fourth embodiment acquires demand information containing essential information of real estate properties from the terminal device 20 and stores the demand information in the demand information database 146. The information acquisition unit 121 also acquires registration information such as user's name, company, email address, and password, and stores them in the demand information database 146. The information acquisition unit 121 acquires map information including property locations based on the locations of properties obtained from essential information. The information acquisition unit 121 acquires the map information from an external map server (not shown in the drawings) via the network N.

The essential information specification unit 123 specifies essential information from the real estate property information in management information. Specifically, the essential information specification unit 123 specifies the description field for essential information from the real estate property information in the management information, based on essential information keywords. The essential information items for real estate properties may be changed upon an instruction from the user via the terminal device 20.

The analysis unit 124 analyzes and extracts the essential information from the real estate property information in the management information of each company. Specifically, the essential information content is analyzed and extracted from the description field of the essential information specified by the essential information specification unit 123. In the case of management information such as a securities report, in which the description field for real estate property information is known in advance, the analysis unit 124 may acquire the content of the essential information from the description field of the real estate information.

The analysis unit 124 performs the matching analysis processing to calculate a matching score. The matching analysis processing compares and analyzes the essential information from a user seeking a real estate property, with the essential information of real estate properties of a company, and calculates matching scores based on the results. The analysis unit 124 stores the calculated matching scores in the score database 145.

The output unit 130 generates and outputs display data that displays an essential information display field containing a property list and matching scores along with the essential information extracted by the analysis unit 124 as individual information of the company. The display data also contains a map information display field that displays the digits in the matching score of the property calculated by the analysis unit 124 overlaid on the position on the map based on the GPS information of the property. The display data is transmitted to the terminal device 20 via the communication unit 11. The terminal device 20 displays keywords based on the display data. The display data may be Web screen data. Specifically, the information analysis device 10 displays the keywords on a Web screen. The terminal device 20 receives the Web screen data and displays it on a browser.

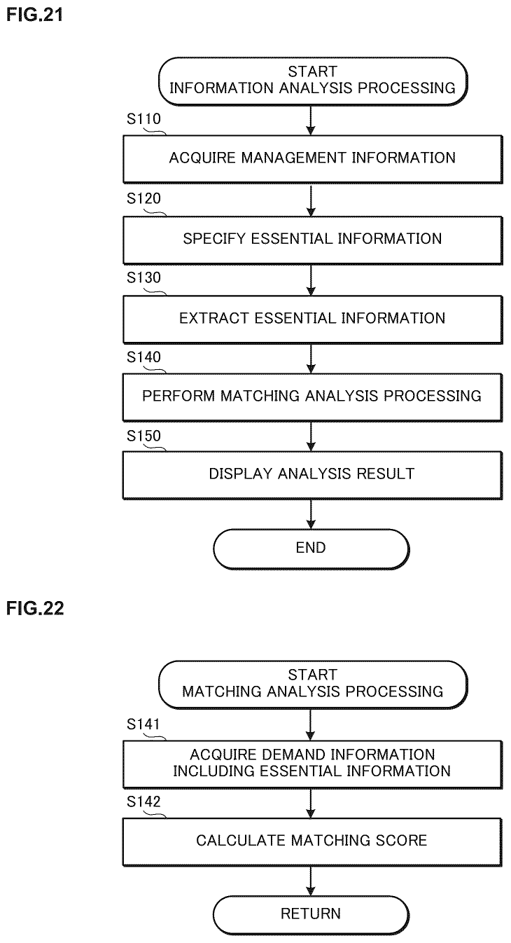

Next, the information analysis processing performed by the information analysis device 10 according to the fourth embodiment will be described, with reference to FIG. 21. FIG. 21 is a flowchart showing a specific example of the information analysis processing. The information analysis processing is executed by the control unit 12 (information acquisition unit 121, essential information specification unit 123, analysis unit 124, output unit 130, and so forth) reading out necessary programs such as an information analysis program from the program storage unit 141.

First, in Step S110 shown in FIG. 21, the control unit 12 acquires management information of each company. Specifically, the information acquisition unit 121 acquires document data of management information of each company from the management information server 30 via the communication unit 11 and stores the document data in the management information database 143. The information acquisition unit 121 stores the obtained management information directly into the management information database 143 if the information is in document data (PDF, XML, XBRL, or the like containing text), which can be text-searched. If the document data cannot be text-searched (such as a PDF file in which the document is captured as an image), the information acquisition unit 121 converts the document data into text-searchable data and then stores it in the management information database 143.

Next, in Step S120, the control unit 12 specifies essential information for a real estate property from the management information acquired by the information acquisition unit 121. Specifically, the essential information specification unit 123 specifies essential information from the real estate property information in the management information. For example, the essential information specification unit 123 specifies the description field for essential information from the real estate property information in the management information, based on the essential information keywords.

Next, in Step S130, the control unit 12 analyzes and extracts the essential information for the real estate property from the management information acquired by the information acquisition unit 121. Specifically, the analysis unit 124 analyzes and extracts the essential information content from the description field of the essential information specified by the essential information specification unit 123, and stores it in the company information database 142.

Next, in Step S140, the control unit 12 performs keyword analysis processing. Specifically, the analysis unit 124 performs a comparative analysis on the essential information for real estate properties contained in the user's demand information, with the essential information for the real estate properties of the company stored in the company information database 142, and calculates matching scores based on the results. The keyword analysis processing is performed as shown in FIG. 22, for example.

FIG. 22 is a flowchart showing a specific example of the matching analysis processing. In the matching analysis processing, in Step S141, the information acquisition unit 121 first acquires demand information containing essential information of real estate properties from the terminal device 20 and stores the demand information in the demand information database 146. Next, in Step S142, matching scores are calculated based on the essential information (needs) for the real estate property contained in the demand information. Specifically, the analysis unit 124 performs a comparative analysis on the essential information for real estate properties contained in the demand information, with the essential information for the real estate properties of the company stored in the company information database 142, and calculates matching scores to be stored in the score database 145. The matching scores represent the analysis results of the matching analysis.

Next, in Step S150 shown in FIG. 21, the control unit 12 causes the terminal device 20 to display the results of the matching analysis. Specifically, the output unit 130 generates display data and transmits it to the terminal device 20, whereby the matching scores are displayed in the essential information display field BL and the map information display field BM as shown in FIG. 20. Specifically, the output unit 130 generates and outputs display data containing the essential information BL that displays a property list along with the essential information extracted by the analysis unit 124, and a map information display field BM that displays the matching score of the property calculated by the analysis unit 124 overlaid on the position on the map based on the GPS information of the property. The processes of Steps S110 to Step S150 are executed in response to the request from the terminal device 20. The processes of Step S110 to Step S130 may be automatically executed by periodically crawling specific management information providing sites.

According to the information analysis device 10 of the fourth embodiment described above, essential information that is specified from real estate property information of a company is analyzed and displayed, and it is therefore possible to narrow down and display specific essential information from numerous sets of information of each property. This allows specific essential information to be visualized as individual information of the company, making it easier to quickly identify a truly necessary real estate property, as compared to the conventional practice of simply incorporating more information. Moreover, essential information for real estate properties is the essential minimum information for searching for a real estate property of a company, enabling matching with such minimal data, and therefore matching of real estate that meets user's needs can be made more easily, as compared to cases where matching is made with more information. As a result, it becomes easier to find a real estate property that meets user's needs.

### Fifth Embodiment

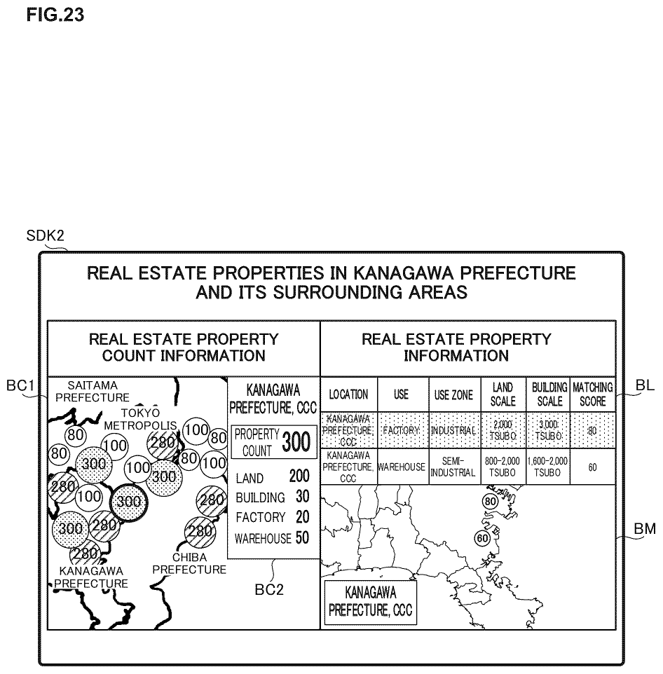

Hereunder, a fifth embodiment of the present invention will be described. The fourth embodiment exemplified the fourth function for displaying the essential information for real estate properties of companies as shown in FIG. 20, whereas as a modified example of the fourth function, the fifth embodiment will exemplify a case where essential information on real estate properties in a region as shown in FIG. 23 is displayed as individual information of the company.

FIG. 23 is a diagram showing a specific example of a display screen SDK2 displayed on the terminal device 20 in the fifth embodiment. In FIG. 23, the essential information display field BL and the map information display field BM of FIG. 20 are arranged vertically for display on the right side as viewed from the front. In FIG. 23, a property count display field BC1 overlaying the real estate property count of each region on the map is displayed, and an essential-information-matched property count display field BC2 is displayed when the real estate property count of FIG. 23 is clicked. According to the property count display field BC1, it is possible to grasp at a glance the number of real estate properties in each region. Additionally, the essential-information-matched property count display field BC2 allows the number of properties to be understood for each item of the essential information, and it is therefore possible to easily approximate properties that meet needs.

FIG. 23 shows a case where the 300 results (portion surrounded by thick circle) in the CCC region of Kanagawa Prefecture is clicked. The essential-information-matched property count display field BC2 of FIG. 23 displays not only the property count (300) in the CCC region of Kanagawa Prefecture, but also the property count for each essential information item (200 lands, 30 buildings, 20 factories, and 50 warehouses) as a breakdown. Among these, a list of properties with a matching score equal to or greater than a predetermined value is displayed in the essential information display field BL, and the map information of the properties is displayed in the map information display field BM. According to this, the map information display field is displayed in which specific essential information display field for an approximate target region and a matching score are overlaid on the map, and it is therefore easy to quickly find properties that meet needs in the approximate targeted region.

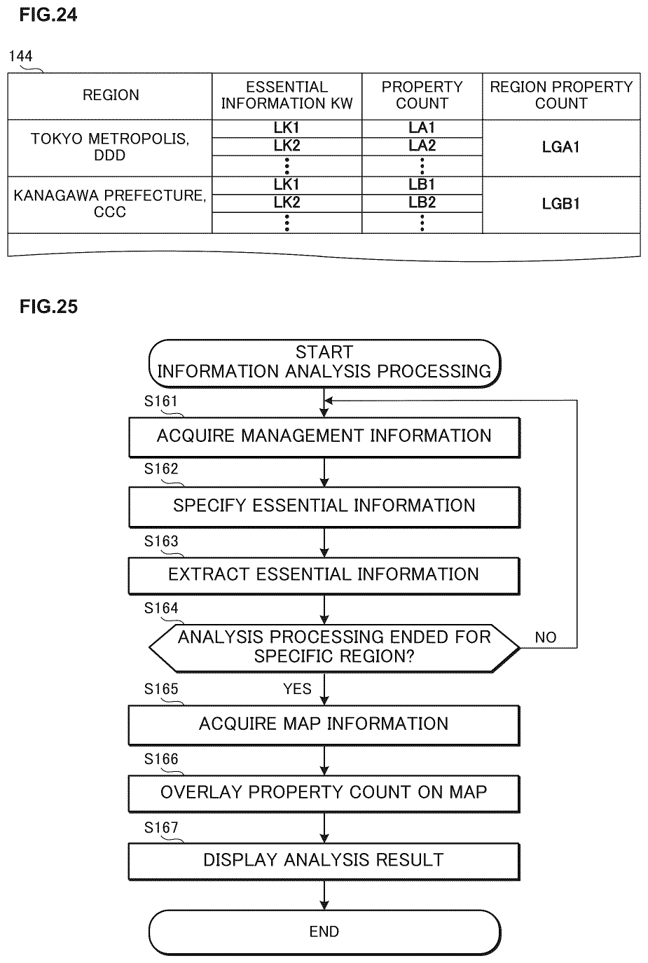

In the keyword database 144 of such fifth embodiment, not only the essential information keywords as shown in FIG. 18 but also the essential information keywords associated with each region and the property count thereof as shown in FIG. 24 are stored. FIG. 24 is a diagram showing a configuration example of an essential information data table according to the fifth embodiment. The data table of FIG. 24 also stores a region property count, which is the total number of properties in the region. For example, according to the data table of FIG. 24, in the DDD region of Tokyo Metropolis, the number of properties for the essential information keyword LK1 is LA1, and the number of properties for the essential information keyword LK2 is LA2. A region property count LGA1 represents the total number of properties for individual essential information in the DDD region of Tokyo Metropolis.

Now, the information analysis processing performed by the information analysis device 10 of such fifth embodiment will be described, with reference to the drawings. FIG. 25 is a flowchart showing a specific example of the information analysis processing according to the fifth embodiment. The processes of Step S161 to Step S163 are the same as those of Step S110 to Step S130, and therefore, the detailed description thereof will be omitted. In the information analysis processing of FIG. 25, the processes of Step S161 to Step S163 are performed for a specific region, thereby acquiring real estate essential information from management information of companies in the region. As with the fourth embodiment, essential information may be acquired by receiving the essential information from terminal device 20 input by users wishing to offer real estate properties.

Then, in Step S164, the control unit 12 determines whether or not an analysis process for a specific region has been completed, and if the analysis process is determined as having been completed, the control unit 12 acquires map information for the region in Step S165. Next, in Step S166, the control unit 12 overlays the real estate property count of each region on the map, and in Step S167, causes the terminal device 20 to display the analysis result. Specifically, the output unit 130 generates display data and transmits it to the terminal device 20, whereby the property count display field BC1 overlaying the real estate property count of each region on the map is displayed as shown in FIG. 23.

According to such fifth embodiment, the property count display field overlaying the real estate property count of each region on the map is displayed as shown in FIG. 23, and it is therefore possible to grasp at a glance the number of real estate properties in each region. Additionally, the essential-information-matched property count display field BC2 allows the number of properties to be understood for each item of the essential information, and it is therefore possible to easily approximate company real estate properties that meet needs.

### Sixth Embodiment

Hereunder, a sixth embodiment of the present invention will be described. The sixth embodiment will exemplify a case of combining the fourth function described above with the third function, in which the management information of multiple companies is analyzed, whereby a potential client company candidate list selected for being likely to engage in real estate transactions is displayed on the terminal device 20. According to such a combination, among the companies listed in the potential client company candidate list, the individual information of a company specified by hovering the cursor over or clicking on the company (including essential information for real estate property information of the company, and map information) can be displayed on the same screen of the terminal device 20.

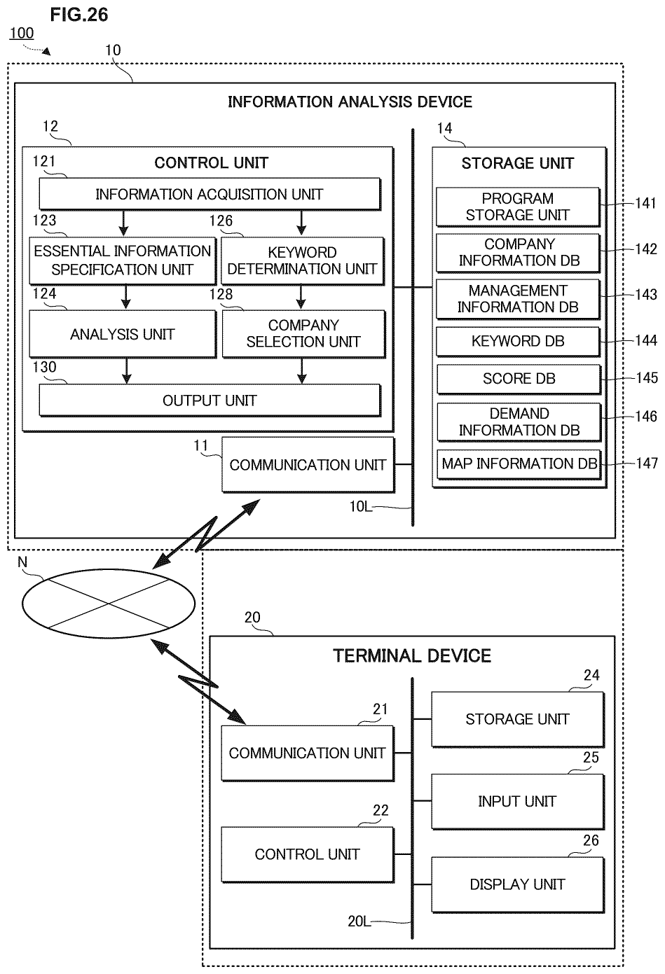

An information analysis device 10 of such sixth embodiment will be described below, with reference to the drawings. FIG. 26 is a block diagram showing a specific configuration example of the information analysis device according to the sixth embodiment. FIG. 26 differs from FIG. 17 in that a keyword determination unit 126 and a company selection unit 128 are provided in the control unit 12. A keyword database 144 (keyword DB) of the sixth embodiment stores specific keywords and weighting factors. These configurations are the same as those of FIG. 11, and therefore detailed description thereof will be omitted. The information analysis processing of the third function performed in the sixth embodiment is the same as that shown in FIG. 14 and FIG. 15, and the information analysis processing of the fourth function is the same as that in FIG. 21 and FIG. 22.

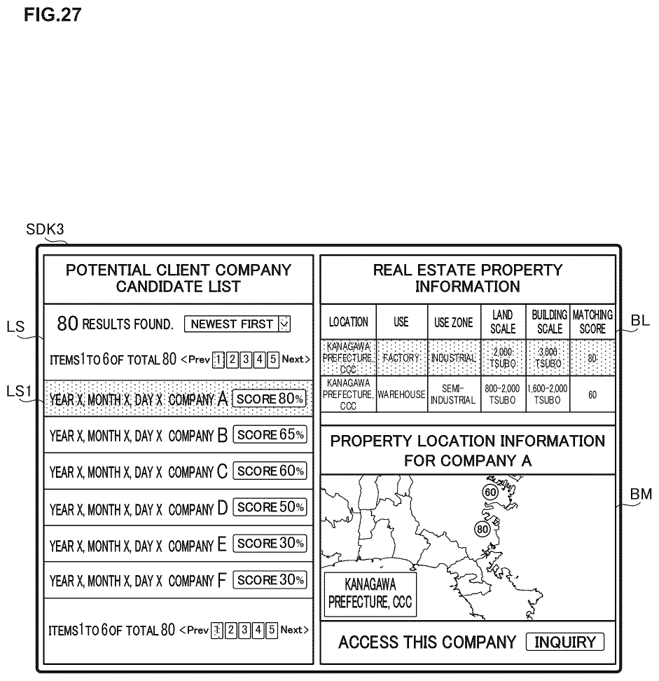

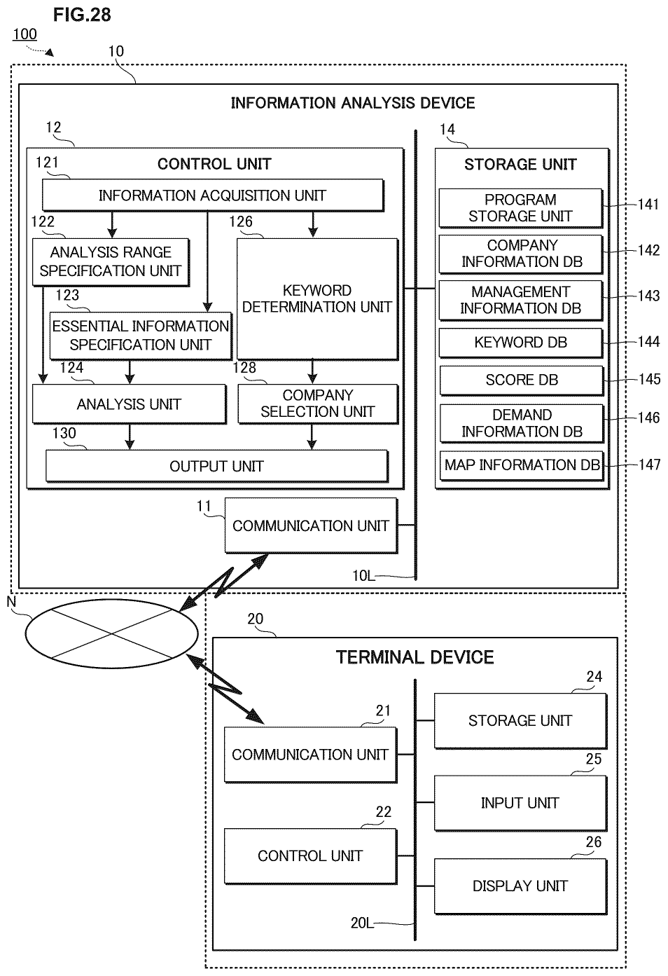

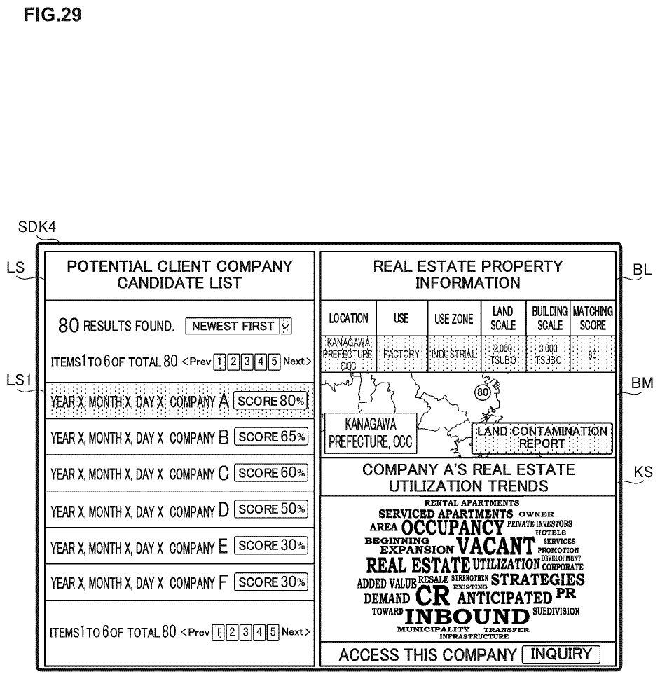

In the sixth embodiment, a specific example of a display screen SDK3 displayed on the display unit 26 of the terminal device 20 is shown in FIG. 27. FIG. 27 is a diagram showing a specific example of the display screen SDK3 according to the sixth embodiment. A company candidate display field BL and an essential information display field BM are displayed on the display screen SDK3. The essential information display field BL displays essential information and matching scores as real estate property information of companies. The map information display field BM displays map information of the property displayed in the essential information display field BL.

In FIG. 27, when the display screen SDK3 is viewed from the front, the company candidate display field LS is arranged on the left side, and the essential information display field BL and the map information display field BM are arranged on the right side. The essential information display field BL and the map information display field BM are arranged vertically for display on the display screen SDK1. The positioning of the company candidate display field LS, the essential information display field BL, and the map information display field BM is not limited to the example shown in the figure, and they may be arranged in any manner.

In the company candidate display field LS, a potential client company candidate list is displayed as approach information. In this potential client company candidate list, companies with higher scores are displayed higher. As a result, companies with a higher likelihood of sales success can be ranked higher for display. The company candidate display field LS displays the number of potential companies (for example, 80 results found), page switching buttons, and so forth. Each of individual company display fields LS1 displayed in the list displays, for example, “date”, “company name”, and “potential client score” are displayed. It should be noted that the display items are not limited to those shown in the figure, and items such as “stock code”, “listing market”, “capitalization”, “industry sector”, “business type”, “employee count”, “financial closing date”, “location”, “business particulars”, and “remarks” may be added. Also, a search period field in which input of a period can be made may be provided, thereby refining the display to companies selected through the management information analysis within the input period.

The output unit 130 of the sixth embodiment generates and outputs display data that displays a specified potential client company candidate in an emphasized manner within the company candidate display field LS, as shown in FIG. 27. Moreover, the display data also arranges and displays individual information of the specified potential client company candidate (including essential information for real estate property information of the company, and map information) alongside the specified potential client company candidate, within the company candidate display field LS. As a result, for example, a company is specified by clicking on or hovering the cursor over any of the companies listed in the company candidate display field LS, and the individual information of the specified company is then displayed therealongside within the company candidate display field LS.

Specifically, each company display field LS1 (individual company display frame) in FIG. 27 is a button, and when a company display field LS1 is clicked on with a mouse or the like of the input unit 25, the essential information and matching scores of real estate properties owned by the company are displayed in the essential information display field BL, and also the map information of the properties is displayed in the map information display field BM. FIG. 27 is an example of the display when company A, located at the top of the individual company display fields LS1, is clicked, and accordingly, the essential information display field BL displays essential information and matching scores as real estate property information of company A, and the map information display field BM displays the map information of the properties.

Then, when company B among the potential client company candidates on the display screen SDK3 in FIG. 27 is clicked, company B is specified and emphasized for display (by changing the color, shading, changing the font, and so forth). Furthermore, the essential information display field BL displays essential information and matching scores as real estate property information of company B, and the map information display field BM displays the map information of the properties. Also, an “Inquiry” button may be displayed on the display screen SDK3 as shown in FIG. 27. As a result, on the same screen as the display screen showing the potential client company candidate list, essential information of real estate properties, map information, and so forth, it is possible to directly inquire about the company and their real estate information.

According to such sixth embodiment, not only a list of potential client company candidates with a higher likelihood for real estate transactions is displayed, but also the essential information for real estate properties of each company and matching scores thereof, as well as the map information the real estate properties are displayed in an arranged manner. As a result, based on company management information, companies with potential real estate transaction demands are displayed as potential client company candidates, and even essential information and matching scores serving as real estate property information are visualized as individual information of the companies, and it is therefore possible to find the minimal necessary property information can be grasped at a glance, and the process of finding a company that owns a desired commercial real estate becomes easier. Furthermore, when a potential client company candidate is specified, individual information on the company is displayed. Specifically, by clicking on potential client company candidates one after another, it is possible to see essential information for the real estate properties owned by companies one after another, making it easier to find a desired potential client company and develop sales strategies for the potential client company.

### Seventh Embodiment

Hereunder, a seventh embodiment of the present invention will be described. The seventh embodiment will exemplify a case of combining the first function and the fourth function described above with the third function in which a list of potential client company candidates by analyzing their management information using specific keywords relevant to real estate transactions. According to such a combination, among the companies listed in the potential client company candidate list, the individual information of a company specified by hovering the cursor over or clicking on the company (including real estate keywords indicating the real estate utilization trends of the company and hot keywords indicating industry trends, and even including essential information for real estate property information and map information of the company) can be displayed on the same screen of the terminal device 20.

FIG. 20 is a block diagram showing a specific configuration example of an information analysis device according to the seventh embodiment. The information analysis device 10 of FIG. 20 differs from that in FIG. 15 in that not only an essential information specification unit 123 but also an analysis range specification unit 122 are provided in the control unit 12.

FIG. 21 is a diagram showing a specific example of a display screen SDK4 according to the seventh embodiment. A company candidate display field LS, an essential information display field BL, a map information display field BM, and a first keyword display field KS1 are displayed on the display screen SDK4. According to this, a potential client company candidate list is displayed in the company candidate display field LS, essential information and map information for real estate properties of the company are displayed in the essential information display field BL and in the map information display field BM, and keywords for grasping the real estate utilization trends of the company are displayed in the first keyword display field KS1.

According to this, it is possible, at a glance, to grasp the essential information and matching scores for the real estate properties owned by the company that is likely to have real estate transaction demands and is displayed on the potential client company candidate list, and also grasp even the real estate utilization trends of the company. Therefore, without relying on the experience and intuition of skilled sales representatives, it is possible to develop strong real estate sales strategies for the company, and by presenting plans tailored to the company's needs, it is possible to increase the success rate of sales. Furthermore, keywords can be displayed so that the real estate utilization trends of the company can be grasped at a glance, significantly reducing the time and effort required for strategy development and making sales activities more efficient.

It should be noted that external functions other than the first through fourth functions may also be linked to the display screen. For example, in FIG. 21, a banner linking to an external function (land contamination report) is placed in the map information display field BM. Clicking on this banner may open an external service site that provides land contamination reporting service. Furthermore, banners other than the land contamination reporting service may be placed to provide links to external services such as urban planning information, aerial photograph history, or hazard maps, which allows for further expansion of the services.

The present invention is not limited to the aforementioned embodiments described above, and various applications and modifications are possible. It is also possible to combine one or more of these modified aspects and the aforementioned embodiments in an arbitrarily selected manner. Furthermore, it is apparent to those skilled in the art that various modifications or alterations can be conceived within the scope of the claims, and these should naturally be understood as belonging to the technical scope of the present invention.

While the aforementioned first to seventh embodiments exemplified a plurality of functions (first through fourth functions) for displaying information obtained by analyzing management information of a plurality of companies, one or more of these first through fourth functions can be selectively combined and displayed on the same display screen. In addition to the combinations of the embodiments described above, for example, the first function for displaying real estate keywords and the second function for displaying hot keywords can also be combined with the fourth function for displaying essential information for a real estate property owned by the company and be displayed on the same display screen. With these combinations, real estate keywords of the company and hot keywords in the industry are displayed as individual information of the company, on the same screen as the essential information for the real estate property owned by the company, the transaction and utilization trends of the real estate property can be forecasted at a glance, facilitating development of sales strategies for the company.

### REFERENCE SIGNS LIST

10: Information analysis device, 11: Communication unit, 12: Control unit, 14: Storage unit, 20: Terminal device, 21: Communication unit, 22: Control unit, 24: Storage unit, 25: Input unit, 26: Display unit, 30: Management information server, 100: Information analysis system, 121: Information acquisition unit, 122: Analysis range specification unit, 123: Essential information specification unit, 124: Analysis unit 126: Keyword determination unit, 128: Company selection unit, 130: Output unit, 141: Program storage unit, 142: Company information database, 143: Management information database, 144: Keyword database, 145: Score database, 146: Demand information database, 147: Map information database, 150: Output unit, KS: Keyword display field, KS1: First keyword display field, KS2: Second keyword display field, BC1: Property count display field, BC2: Essential-information-matched property count display field, BL: Essential information display field, BM: Map information display field, LS: Company candidate display field, LS1: Company display field, N: Network

1-15. (canceled)

16. An information analysis device comprising:
an information acquisition unit that acquires management information of a plurality of companies;
an analysis range specification unit that specifies, from the management information, items that contain real estate keywords relevant to real estate utilization of the companies as an analysis range for the management information;
an analysis unit that extracts a keyword contained in the items specified by the analysis range from among keywords contained in management information of each of the companies acquired by the information acquisition unit; and
an output unit that outputs display data for displaying a keyword display field containing the real estate keyword of the company extracted by the analysis unit as individual information for the company,
wherein the information acquisition unit also acquires past management information in past of current management information that has been acquired,
wherein the analysis unit compares the items specified by the analysis range specification unit in the current management information and the past management information, and extracts, as a latest keyword from among keywords contained in the current management information, a keyword that is not contained in the past management information of the company, and
wherein the output unit outputs display data for displaying the latest keyword in the keyword display field in priority to another keyword.

17. The information analysis device according to claim 16,
wherein the keyword display field includes a first keyword display field that contains the real estate keyword and a second keyword display field that contains a hot keyword relevant to a trend in an environment surrounding the company,
wherein the analysis range specification unit specifies, as an analysis range of the real estate keyword, an item that contains the real estate keyword from the management information,
wherein the analysis unit separately performs analysis of the real estate keyword and analysis of the hot keyword from keywords contained in the management information acquired by the information acquisition unit, and while performing each analysis, compares the items specified by the analysis range specification unit in the current management information and the past management information and extracts, as a latest keyword from among keywords contained in the current management information, a keyword that is not contained in the past management information of the company, and
wherein the output unit outputs display data for displaying, in the first keyword display field, the latest keyword extracted by analysis of the real estate keyword in priority to another keyword and for displaying, in the second keyword display field, the latest keyword extracted by analysis of the hot keyword in priority to another keyword.

18. The information analysis device according to claim 17,
wherein the hot keyword includes a hot keyword associated with each industry,
wherein the analysis range specification unit specifies, as an analysis range, management information of the plurality of companies included in an industry of the company of the management information acquired by the information acquisition unit, and
wherein the analysis unit analyzes and extracts a hot keyword associated with the industry from the management information within the analysis range.

19. The information analysis device according to claim 18,
wherein, in the analysis of the real estate keyword, the analysis unit calculates, as a word score, a rate of increase in a ratio of an occurrence count of each of the real estate keywords relative to a total occurrence count of all the real estate keywords in the analysis range that has been specified,
wherein, in the analysis of the hot keyword, the analysis unit calculates, as a word score, a rate of increase in a ratio of an occurrence count of each of the hot keywords relative to a total occurrence count of all the hot keywords in the analysis range that has been specified, and
wherein the output unit outputs display data for displaying, in each of the first keyword field and the second keyword field, keywords that are emphasized according to the word scores.

20. The information analysis device according to claim 19,
wherein the analysis unit separately extracts the real estate keyword contained in the management information acquired by the information acquisition unit and the real estate keyword contained in the past management information, and
wherein the output unit outputs display data for displaying, in the first keyword display field, the real estate keyword contained in the past management information in addition to the real estate keyword contained in the management information acquired by the information acquisition unit.

21. The information analysis device according to claim 20,
wherein the information acquisition unit acquires real estate property information of the plurality of companies,
wherein the information analysis device comprises an essential information specification unit that specifies essential information for real estate properties from the real estate property information,
wherein the analysis unit analyzes and extracts the essential information from the real estate property information of each of the companies acquired by the information acquisition unit, and
wherein the output unit outputs display data for displaying an essential information display field containing the essential information of the company extracted by the analysis unit as individual information of the company.

22. The information analysis device according to claim 21,
wherein the information acquisition unit acquires real estate property information containing at least a location, a use, a use zone, and a scale of the real estate property from management information of a company, and
wherein the analysis unit analyzes and extracts the essential information from the real estate property information of the management information.

23. The information analysis device according to claim 22,
wherein the information acquisition unit acquires demand information containing essential information for the real estate properties,
wherein the analysis unit calculates a matching score by comparing and analyzing the essential information for the real estate properties in the demand information and the essential information for the real estate properties extracted by the analysis unit, and
wherein the display data contains data for displaying the essential information in descending order of the matching score.

24. The information analysis device according to claim 23,
wherein the information acquisition unit acquires map information, and
wherein the display data contains an essential information display field that displays essential information for real estate properties having the matching score equal to or greater than a predetermined value, and a map information display field that displays the matching score overlaid on a map from the map information and positions of the real estate properties on the map.

25. The information analysis device according to claim 24,
wherein the display data contains a property count display field that displays the number of real estate properties for each region on the map, and an essential-information-matched property count display field that displays the number of properties for each item of the essential information.

26. The information analysis device according to claim 16, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

27. The information analysis device according to claim 17, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

28. The information analysis device according to claim 18, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

29. The information analysis device according to claim 19, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

30. The information analysis device according to claim 20, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

31. The information analysis device according to claim 21, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

32. The information analysis device according to claim 22, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

33. The information analysis device according to claim 23, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

34. The information analysis device according to claim 24, comprising:
a storage unit that stores a specific keyword relevant to a real estate transaction of a company,
a keyword determination unit that determines whether or not the specific keyword is contained in management information acquired by the information acquisition unit, and
a company selection unit that selects as a potential client company candidate a company determined by the keyword determination unit as containing the specific keyword in the management information,
wherein the output unit outputs display data for displaying a company candidate display field containing the potential client company candidate selected by the company selection unit, and display data for displaying in an emphasized manner a company specified in the company candidate display field and for listing and displaying the individual information of the specified company in the company candidate display field.

35. A tangible non-transitory computer-readable storage medium that is computer-readable and stores therein a program for causing a computer to execute information analysis processing on management information containing a real estate keyword relevant to real estate utilization of a company,
wherein the information analysis processing comprises steps of:
acquiring management information of a plurality of companies;
specifying, from the management information, items that contain real estate keywords as an analysis range for the management information;
extracting a keyword contained in the items specified by the analysis range from among keywords contained in management information of each of the companies acquired by the information acquisition unit; and
outputting display data for displaying a keyword display field containing the real estate keyword of the company extracted by the analysis unit as individual information for the company,
wherein, in the step of acquiring the management information, past management information in past of current management information that has been acquired is also acquired,
wherein, in the step of extracting the keyword, the items specified by the analysis range in the current management information and the past management information are compared, and from among keywords contained in the current management information, a keyword that is not contained in the past management information of the company is extracted as a latest keyword, and
wherein, in the step of outputting the display data, display data for displaying the latest keyword in the keyword display field in priority to another keyword are outputted.
